(19) United States
(12) Patent Application Publication
(10) Pub. No.: US 2026/0366668 A1
(43) Pub. Date: Nov. 19, 2026

(54) INSULATING SUPPORT FOR PIPE HANGER LOCATIONS

(71) Applicant: Stilli Manufacturing, LLC, Frederick, MD (US)

(72) Inventor: Matthew Mark Stillitano, Middletown, MD (US)

(21) Appl. No.: 19/678,074

(22) Filed: May 14, 2026

Related U.S. Application Data
(60) Provisional application No. 63/806,967, filed on May 16, 2025.
(60) Provisional application No. 63/840,942, filed on Jul. 9, 2025.
(60) Provisional application No. 63/876,809, filed on Sep. 5, 2025.
(60) Provisional application No. 63/971,976, filed on Jan. 30, 2026.

(51) Int. Cl. F16L 59/135; F16L 59/10

(52) U.S. Cl. CPC F16L 59/135; F16L 59/10

(57) ABSTRACT

The present teachings include pipe hanger supports for protecting and maintaining the integrity of insulation disposed about pipes at hanger locations. To this end, the present teachings may include a single-body pipe hanger support with integrated support inserts, the structure thereof formed from weatherproof and durable materials such as rubber. The pipe hanger support may include both releasable and permanent fasteners, allowing for temporary engagement during installation and adjustment, followed by secure permanent attachment. The support may include a continuous insulating medium having sufficient flexibility for wrapping around a pipe. This design can be useful for durability, enhancing weatherproofing, simplifying installation, and effectively protecting pipe insulation from crushing at hanger locations. The integrated nature of the support inserts and flexible materials address limitations of traditional calcium silicate supports, offering improved performance while maintaining the structural integrity of insulation.

### CROSS-REFERENCE TO RELATED APPLICATIONS

This application claims priority to U.S. Provisional Patent Application No. 63/806,967 filed on May 16, 2025, U.S. Provisional Patent Application No. 63/840,942 filed on Jul. 9, 2025, U.S. Provisional Patent Application No. 63/876,809 filed on Sep. 5, 2025, and U.S. Provisional Patent Application No. 63/971,976 filed on Jan. 30, 2026. Each of the foregoing applications is hereby incorporated by reference in its entirety.

### FIELD

The present disclosure generally relates to pipe hanger supports for protecting, and maintaining the integrity of, insulation disposed about pipes at pipe hanger locations, e.g., single-body pipe hanger supports with integrated support inserts for protecting insulation at hanger locations.

### BACKGROUND

Pipe hanger supports for insulated pipes, such as chilled water pipes, can be used to prevent the crushing of insulation at hanger locations thereby maintaining structural integrity and/or thermal properties of the insulation. Typically, such hanger supports include two pieces of pre-formed calcium silicate that are glued together on site, a configuration which can be cumbersome and problematic for shipping, storage, and installation. Additionally, calcium silicate is not weatherproof and can be brittle, potentially breaking during transport, storage, or installation. Furthermore, dust from calcium silicate materials presents a respiratory hazard of particular concern for installers handling the material and for installations in sensitive environments, such as hospitals. There is room for improvement in the design and materials used for pipe hanger supports to enhance durability, ease of installation, and overall performance in protecting pipe insulation.

There remains a need for improved pipe hanger supports that are more durable, weatherproof, and easier to install while effectively protecting pipe insulation from being crushed at hanger locations.

### SUMMARY

The present teachings generally include pipe hanger supports for protecting and maintaining the integrity of insulation disposed about pipes at hanger locations. To this end, the present teachings may include a single-body pipe hanger support with integrated support inserts, the structure thereof formed from weatherproof and durable materials such as rubber. The pipe hanger support may include a continuous insulating medium having sufficient flexibility for wrapping around a pipe. The support may include both releasable and permanent fasteners, allowing for temporary engagement during installation and adjustment, followed by secure permanent attachment. This design can be useful for durability, enhancing weatherproofing, simplifying installation, and effectively protecting pipe insulation from crushing at hanger locations. The integrated nature of the support inserts (which may, e.g., be embedded within the insulating medium) and flexible materials address limitations of traditional calcium silicate supports, offering improved performance while maintaining the structural integrity of insulation.

In an example aspect, a support for safeguarding insulation at a pipe hanger location disclosed herein includes: an insulating medium formed as a continuous body defining a length between a first end and a second end, the length selected to substantially envelop a circumference of a pipe, each of the first end and the second end including a mating surface for coupling therebetween; a plurality of support inserts embedded within the continuous body of the insulating medium, the plurality of support inserts including at least three primary support inserts positioned at a first location along the length of the insulating medium, the first location selected to be adjacent to at least one of a bottom end or a top end of the pipe when the insulating medium is wrapped about the pipe; a first side support insert positioned at a second location along the length of the insulating medium, the second location selected to be adjacent to a first side of the pipe when the insulating medium is wrapped about the pipe; and a second side support insert positioned at a third location along the length of the insulating medium, the third location selected to be adjacent to a second side of the pipe when the insulating medium is wrapped about the pipe; a first fastener disposed on the mating surface of at least one of the first end and the second end of the insulating medium, the first fastener structurally configured to couple the first end and the second end; a vapor barrier disposed on an exterior surface of the insulating medium; and a second fastener at least partially disposed on the vapor barrier, the second fastener structurally configured to further couple the first end and the second end of the insulating medium.

Implementations of this example aspect, or any other example aspect described in this summary section or otherwise herein, may include one or more of the following features. The at least three primary support inserts may be spaced apart with a predetermined spacing. The predetermined spacing may be selected to distribute compressive forces substantially evenly across the insulating medium at the first location. The mating surface of one or more of the first end and the second end may include an angled or beveled edge that creates complementary mating surfaces when the first end and the second end are coupled. The first fastener may include an adhesive component. The adhesive component may include a double-sided tape. The adhesive component may be pre-applied during manufacturing and protected by a release liner until installation. The second fastener may include a self-sealing lap tape. The self-sealing lap tape may be configured to overlay a location of the first fastener. The support may include a breakaway seam disposed along the vapor barrier, the breakaway seam may include a breakable connection between the first end and the second end that permits the support to be shipped in a substantially cylindrical configuration and opened for installation about the pipe. The breakaway seam may be positioned along a side of the support disposed away from the at least three primary support inserts at the first location. The support may include a first insulation shield positioned adjacent to the first location for disposition between the pipe and a portion of a pipe hanger. The support may include a second insulation shield positioned opposite the first location. The first insulation shield and the second insulation shield may be configured to overlap to form a substantially continuous protective encasement around the insulating medium. One or more of the first insulation shield and the second insulation shield may be formed from a metal material. One or more of the first insulation shield and the second insulation shield may be formed from 16-gauge galvanized steel. The vapor barrier may extend continuously across the exterior surface of the insulating medium. The insulating medium may be formed from a weatherproof material. The weatherproof material may include rubber. The insulating medium may lack calcium silicate. The plurality of support inserts may include at least one of: high-density molded fiberglass, calcium silicate, phenolic foam, a polymer, or wood. The support may include one or more markings on the insulating medium indicating at least one of: an alignment guide for placement at one or more of the bottom end of the pipe and the top end of the pipe, and a location of at least one of the plurality of support inserts. The insulating medium may define a width of 12 inches or greater. The insulating medium may define a thickness of 1 inch or greater. The support may include a channel formed in an inner surface of the insulating medium, the channel sized and shaped to receive a pipeline component therethrough. The pipeline component may include a heat trace cable. The support may include a plurality of channels through the insulating medium.

In an example aspect, a system for safeguarding insulation disposed about a pipe at a hanger location disclosed herein includes: a pipe having a circumference with a top end and a bottom end; a pipe hanger including a hanger body adapted to suspend from a support structure; and a load-bearing member coupled to the hanger body, the load-bearing member structurally configured to receive and support the pipe along the bottom end thereof; an insulation shield adapted for placement along the load-bearing member, between the load-bearing member and the bottom end of the pipe; and a pipe hanger support including an insulating medium formed as a continuous body defining a length between a first end and a second end, the length selected to substantially envelop the circumference of the pipe, each of the first end and the second end including a mating surface for coupling therebetween; a plurality of support inserts embedded within the continuous body of the insulating medium, the plurality of support inserts including at least three primary support inserts positioned at a first location along the length of the insulating medium, the first location selected to be adjacent to at least one of a bottom end or a top end of the pipe when the insulating medium is wrapped about the pipe; a first side support insert positioned at a second location along the length of the insulating medium, the second location selected to be adjacent to a first side of the pipe when the insulating medium is wrapped about the pipe; and a second side support insert positioned at a third location along the length of the insulating medium, the third location selected to be adjacent to a second side of the pipe when the insulating medium is wrapped about the pipe; a first fastener disposed on the mating surface of at least one of the first end and the second end of the insulating medium, the first fastener structurally configured to couple the first end and the second end; a vapor barrier disposed on an exterior surface of the insulating medium; and a second fastener at least partially disposed on the vapor barrier, the second fastener structurally configured to further couple the first end and the second end of the insulating medium.

Implementations of this example aspect, or any other example aspect described in this summary section or otherwise herein, may include one or more of the following features. The insulating medium may be rubber. The insulating medium may be formed from at least one of: a sheet of rubber, or a roll of rubber material. The insulating medium may have operating temperatures ranging from, and including, -57 degrees Celsius to 125 degrees Celsius. The insulating medium may be weatherproof. A top surface and a bottom surface of the insulating medium may include a vapor barrier that is not compromised from inclusion of the embedded support inserts. The insulating medium may lack calcium silicate. The insulating medium may define a width of about 14 inches. The insulating medium may define a thickness between about 1 inches to about 2 inches, inclusive. The first fastener may include a hook and loop component. The first fastener may lack an adhesive. The second fastener may include a tape component. The tape component may include a self-sealing tape. The second fastener may include an adhesive. The one or more support inserts may include a calcium silicate material. The one or more support inserts may include at least two inserts spaced at least 1-inch apart. The system may include one or more support inserts embedded within the continuous body of the insulating medium at a second location along the length, the second location selected such that the insulating medium, when wrapped about the pipe, envelops the pipe with support inserts disposed adjacent to the top end of the pipe. Support inserts at the second location may be structurally configured to protect the insulating medium from a top portion of the pipe hanger. The pipe hanger may include a U-bolt clamp, and the top portion of the pipe hanger may include a bolt of the U-bolt clamp. The system may include a second insulation shield placed between the top end of the pipe and the top portion of the pipe hanger. The one or more support inserts may include at least one of: high-density molded fiberglass, phenolic foam, a polymer, and wood. The system may include one or more markings on the pipe hanger support, the one or more markings indicating at least one of: an alignment guide for placement at one or more of the bottom end of the pipe and the top end of the pipe, and a location of at least one of the one or more support inserts. The pipe may have a diameter of 4-inches or greater. The pipe may be a chilled water pipe. The system may include a heat trace cable disposed between the pipe hanger support and the pipe. The system may include a sealing compound applied to the pipe hanger support. The sealing compound may be present on tape applied to the pipe hanger support and one or more adjacent insulation portions along the pipe. The system may include one or more adjacent insulation portions along the pipe, the one or more adjacent insulation portions made of at least one of: rubber, fiberglass, polyisocyanurate, foam glass, and calcium silicate. The system may include a protective jacket applied to the pipe hanger support. The pipe hanger may be one or more of a clevis hanger and a band hanger. The pipe hanger may include a U-bolt clamp. The load-bearing member may have a concave profile. The insulation shield may have a curved profile. The insulation shield may include a curved metal sheet. The insulation shield may be part of the pipe hanger support. The insulation shield may be a sheet of material coupled to an outer surface of the insulating medium. The insulation shield may be adhered to the outer surface of the insulating medium. The insulation shield may be a sheet of material embedded within the insulating medium. One or more of the first end and the second end of the continuous body of the insulating medium may include an angled or beveled edge that create complementary mating surfaces. The system may include a load distribution member disposed outside of the insulating medium. The system may include an outer protective layer that, at least in part, maintains a position of the load distribution member.

In an example aspect, a pipe hanger support for safeguarding insulation for a hanging pipe at a pipe hanger location disclosed herein includes: an insulating medium formed as a continuous body defining a length between a first end and a second end; one or more support inserts embedded within the continuous body of the insulating medium at a first location along the length, a flexibility of the insulating medium and a predetermined spacing between the one or more support inserts permitting: (i) the insulating medium with the one or more support inserts embedded therein to be wrapped about an external circumference of a pipe, and (ii) the insulating medium with the one or more support inserts embedded therein to be stored substantially flat, the first location selected such that insulating medium, when wrapped about the pipe, envelops the pipe with the one or more support inserts disposed adjacent to a bottom end of the pipe for positioning between the bottom end of the pipe and a pipe hanger; a first fastener disposed on one or more of the first end and the second end of the continuous body of the insulating medium, the first fastener structurally configured to selectively and releasably couple the first end and the second end of the insulating medium; and a second fastener configured to form a permanent bond between the first end and the second end of the insulating medium.

In an example aspect, a method of manufacturing a pipe hanger support for safeguarding insulation for a hanging pipe at a pipe hanger location disclosed herein includes: forming an insulating medium into a continuous body having a predetermined length having a first end and a second end, the predetermined length selected to substantially envelop a circumference of a pipe, each of the first end and the second end including a mating surface for coupling therebetween; embedding within the continuous body of the insulating medium a plurality of support inserts including at least three primary support inserts at a first location along the predetermined length of the insulating medium, the first location selected to be adjacent to at least one of a bottom end or a top end of the pipe when the insulating medium is wrapped about the pipe; a first side support insert at a second location along the predetermined length of the insulating medium, the second location selected to be adjacent to a first side of the pipe when the insulating medium is wrapped about the pipe; and a second side support insert at a third location along the predetermined length of the insulating medium, the third location selected to be adjacent to a second side of the pipe when the insulating medium is wrapped about the pipe; placing a first fastener on the mating surface of at least one of the first end and the second end of the insulating medium, the first fastener structurally configured to couple the first end and the second end; placing a vapor barrier on an exterior surface of the insulating medium; and placing a second fastener at least partially on the vapor barrier, the second fastener structurally configured to further couple the first end and the second end of the insulating medium.

Implementations of this example aspect, or any other example aspect described in this summary section or otherwise herein, may include one or more of the following features. Forming the insulating medium may include cutting material of the insulating medium to the predetermined length. The method may include embedding one or more support inserts within the insulating medium at a second location along the length. The method may include sealing the insulating medium with a weatherproof sealant. The method may include placing one or more markings on the insulating medium. Embedding the plurality of support inserts within the insulating medium may include removal of material of the insulating medium to form a void, and placing at least one of the plurality of support inserts within the void.

In an example aspect, a method of safeguarding insulation for a hanging pipe at a pipe hanger location disclosed herein includes: wrapping an insulating medium about a pipe in a hanger location, the hanger location disposed where a pipe hanger supports, or will support, the pipe, the insulating medium including a continuous body defining a length between a first end and a second; one or more support inserts embedded within the continuous body at a first location along the length; and a first fastener disposed on one or more of the first end and the second end of the continuous body, the first fastener structurally configured to selectively and releasably couple the first end and the second end of the insulating medium; aligning the one or more supports adjacent to a bottom end of the pipe; releasably coupling the first end and the second end of the insulating medium via the first fastener; positioning an insulation shield beneath the one or more embedded supports; positioning a supporting member of the pipe support beneath the insulation shield; and supporting the pipe using the pipe support.

Implementations of this example aspect, or any other example aspect described in this summary section or otherwise herein, may include one or more of the following features. The method may include permanently coupling the first end and the second end of the insulating medium via a second fastener. The second fastener may be disposed on the insulating medium. The method may include uncoupling the first end and the second end of the insulating medium via the first fastener. The method may include installing a component between the insulating medium and the pipe. The component may include heat tracing. The method may include adjusting a position of the insulating medium relative to the pipe. The method may include aligning at least one of the one or more supports adjacent to a top end of the pipe, and positioning a second supporting member of the pipe support adjacent to the top end of the pipe. The method may include obtaining the insulating medium from a storage location where it is stored substantially flat. Aligning the one or more supports may include use of an alignment guide disposed on the insulating medium.

In an example aspect, an insulating support disclosed herein includes: an insulating medium formed as a continuous body defining a length between a first end and a second end, the length substantially equal to, or greater than, a width of a duct; a plurality of support inserts embedded within the continuous body of the insulating medium, each of the plurality of support inserts spaced apart with a predetermined spacing along the length of the insulating medium, the insulating medium with the support inserts being positionable between a bottom surface of the duct and a support structure to prevent crushing of insulation disposed on the duct; and one or more fasteners configured to secure the insulating medium to the duct.

Implementations of this example aspect, or any other example aspect described in this summary section or otherwise herein, may include one or more of the following features. The plurality of support inserts may include at least four support inserts spaced apart across the length of the insulating medium. The one or more fasteners may include magnets. The one or more fasteners may be configured for temporary attachment of the insulating medium to the duct. The one or more fasteners may include a permanent fastener configured to permanently secure the insulating medium to the duct. The insulating medium may be formed from a weatherproof material. The weatherproof material may include rubber. The support inserts may be formed from a material having a higher compressive strength than the insulating medium. The insulating medium may maintain a vapor barrier across its entire surface, including areas containing the embedded support inserts. The insulating medium may be flexible.

These and other features, aspects, and advantages of the present teachings will become better understood with reference to the following description, examples, and appended claims.

### BRIEF DESCRIPTION OF THE DRAWINGS

The foregoing and other objects, features and advantages of the devices, systems, and methods described herein will be apparent from the following description of particular embodiments thereof, as illustrated in the accompanying drawings. The drawings are not necessarily to scale, emphasis instead being placed upon illustrating the principles of the devices, systems, and methods described herein. In the drawings, like reference numerals generally identify corresponding elements.

FIG. 1 shows a system for safeguarding insulation, according to a representative example.

FIG. 2 shows a system for safeguarding insulation, according to a representative example.

FIG. 3 shows a first side of a pipe hanger support for safeguarding insulation, according to a representative example.

FIG. 4 shows a second side of a pipe hanger support for safeguarding insulation, according to a representative example.

FIG. 5 shows a first end of a pipe hanger support for safeguarding insulation, according to a representative example.

FIG. 6 shows a second end of a pipe hanger support for safeguarding insulation, according to a representative example.

FIG. 7 shows a pipe hanger support for safeguarding insulation, according to a representative example.

FIG. 8 shows a pipe hanger support for safeguarding insulation, according to a representative example.

FIG. 9 shows a system for safeguarding insulation, according to a representative example.

FIG. 10 shows a system for safeguarding insulation, according to a representative example.

FIG. 11 shows a system for safeguarding insulation, according to a representative example.

FIG. 12 shows a flow chart of a method of manufacturing a pipe hanger support for safeguarding insulation, according to a representative example.

FIG. 13 shows a flow chart of a method of safeguarding insulation for a hanging pipe at a pipe hanger location, according to a representative example.

FIG. 14 shows a pipe hanger support for safeguarding insulation, according to a representative example.

FIG. 15A shows a system for safeguarding insulation in a first installation position, according to a representative example.

FIG. 15B shows a system for safeguarding insulation in a second installation position, according to a representative example.

FIG. 15C shows a system for safeguarding insulation in a third installation position, according to a representative example.

### DETAILED DESCRIPTION

The embodiments will now be described more fully hereinafter with reference to the accompanying figures, in which preferred embodiments are shown. The foregoing may, however, be embodied in many different forms and should not be construed as limited to the illustrated embodiments set forth herein. Rather, these illustrated embodiments are provided so that this disclosure will convey the scope to those skilled in the art.

All documents mentioned herein are hereby incorporated by reference in their entirety. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately” or the like, when accompanying a numerical value, are to be construed as indicating a deviation as would be appreciated by one of ordinary skill in the art to operate satisfactorily for an intended purpose. Similarly, words of approximation such as “about,” “approximately,” or “substantially” when used in reference to physical characteristics, should be understood to contemplate a range of deviations that would be appreciated by one of ordinary skill in the art to operate satisfactorily for a corresponding use, function, purpose, or the like. Ranges of values and/or numeric values are provided herein as examples only, and do not constitute a limitation on the scope of the described embodiments. Where ranges of values are provided, they are also intended to include each value within the range as if set forth individually, unless expressly stated to the contrary. The use of any and all examples, or exemplary language (“e.g.,” “such as,” or the like) provided herein, is intended merely to better illuminate the embodiments and does not pose a limitation on the scope of the embodiments. No language in the specification should be construed as indicating any unclaimed element as essential to the practice of the embodiments.

In the following description, it is understood that terms such as “first,” “second,” “top,” “bottom,” “up,” “down,” and the like, are words of convenience and are not to be construed as limiting terms unless specifically stated to the contrary.

Pipe insulation may play a crucial role in maintaining energy efficiency and/or preventing condensation in various piping systems, such as chilled water applications and the like. However, at pipe hanger locations and/or other similar areas where insulation may be subjected to stress, the insulation may be subjected to significant compressive forces that can compromise its effectiveness. When insulation is compressed at these points, it may lose its thermal properties, leading to energy loss, potential condensation issues, and even corrosion of the pipe surface. This problem is particularly acute in industrial and commercial settings where extensive piping networks are common, and/or where large bore pipes are disposed.

Traditional solutions for protecting insulation at hanger locations often involve the use of pre-formed inserts, typically made of materials like calcium silicate or polyisocyanurate. While these inserts can provide some protection, they present several challenges during installation and long-term use. The installation process may require precise cutting and fitting of the inserts around the pipe and hanger, which can be time-consuming and labor-intensive. Additionally, the brittle nature of materials like calcium silicate makes them susceptible to damage during shipping, storage, handling, and installation. For example, if these existing solutions are stored outside or otherwise subjected to the elements, they can be damaged and rendered unusable. Moreover, in environments with vibration or thermal cycling, these rigid inserts may crack or shift over time, reducing their effectiveness. Furthermore, the non-weatherproof nature of traditional insert materials can lead to degradation in outdoor or high-humidity applications, potentially compromising the entire insulation system at critical support points. And while protective jackets or the like can be used to protect these traditional materials, such protection can be difficult to install, cumbersome, subject to leaks, and so forth.

The devices, systems, kits, and methods disclosed herein may resolve some or all of the aforementioned issues with traditional techniques for insulating pipes at hanger locations, and may in general relate to protecting insulation of a pipe from being compromised at a pipe hanger location—e.g., preventing the insulation from being crushed by the weight of the pipe and its contents at a pipe hanger location (between the pipe and pipe hanger) or otherwise being damaged by the pipe and/or hanger. Thus, in general, the systems, pipe hanger supports, and methods disclosed herein may relate to protecting and maintaining the integrity of insulation disposed about pipes at hanger locations. More specifically, the present teachings may include single-body pipe hanger supports with integrated support inserts, the pipe hanger supports formed from weatherproof and durable materials such as rubber. These pipe hanger supports may be designed to prevent the crushing of insulation at pipe hanger locations while offering improved durability, ease of installation, reduction or elimination of material safety concerns (e.g., elimination of respiratory hazards, such as that from degradation of calcium silicate materials or similar), and improved overall performance compared to traditional supports—e.g., supports made from calcium silicate or the like. These supports may incorporate both releasable and permanent fasteners, allowing for temporary engagement during installation and adjustment, followed by secure permanent attachment. The present teachings may also or instead include pipe hanger supports with a continuous insulating medium capable of being stored in a substantially flat configuration, while having sufficient flexibility for wrapping around a pipe. The design of the present teachings can be particularly useful for enhancing weatherproofing, simplifying the installation processes, and effectively protecting pipe insulation from crushing at hanger locations, especially for applications such as chilled water pipes or other insulated piping systems.

It will be understood that the term “insulation” as used herein may generally refer to a material or combination of materials used to reduce heat transfer (e.g., for heat loss and/or heat gain) between objects or environments. More generally, in the context of pipe systems, insulation may include materials applied around pipes to maintain temperature, prevent condensation, reduce energy loss, and/or protect against external environmental factors. Insulation materials may include, but are not limited to, fiberglass, mineral wool, foam (e.g., polyurethane, polystyrene, polyisocyanurate, elastomeric foam, and the like), and/or other synthetic or natural substances with low thermal conductivity. As described herein, a preferred material for certain aspects of the present teachings may include rubber or the like.

It will be understood that the term “integrity” or the like as used herein may generally refer to the state of being whole, unimpaired, and/or sound in construction. In relation to pipe insulation systems, integrity may encompass the ability of the insulation to maintain its intended function, shape, and properties over time and under various operating conditions—e.g., its R-value, moisture resistance, fire resistance, sound control properties, air permeability or resistance, density, compressive strength, dimensional stability, insect and pest resistance, sustainability and environmental impact, thermal stability, dielectric strength, and the like. This may also or instead include resistance to compression, moisture infiltration, thermal degradation, or other factors that could compromise the insulation’s performance or longevity.

It will be understood that the term “pipe hanger support” or the like as used herein may generally refer to a device, apparatus, or structure designed to protect and maintain the integrity of insulation disposed about pipes at hanger locations. More particularly, a pipe hanger support according to an aspect of the present teachings may include a continuous insulating medium with embedded support inserts, capable of being wrapped around a pipe circumference. The pipe hanger support may be positioned between a pipe and a pipe hanger to prevent crushing of the insulation at the hanger location.

It will be understood that the term “pipe hanger” or the like as used herein may generally refer to a broad range of devices and structures used to support pipes in various orientations and configurations—i.e., not simply by “hanging” but also from underneath and/or from the sides, etc. That is, in some aspects, a pipe hanger may include traditional hanging mechanisms such as clevis hangers, U-bolts, or band hangers, e.g., where a pipe is suspended substantially horizontally (or otherwise) from an overhead support structure or the like. These conventional pipe hangers may incorporate elements such as threaded rods, adjustable clamps, or other fastening components to secure the pipe and allow for height adjustments. However, it will be understood that the term “pipe hanger” may also encompass support structures that hold, orient, and/or support pipes in orientations other than being suspended from above. In some implementations, a pipe hanger may refer to supports that cradle or secure pipes from below, such as pipe shoes, pipe saddles, or framing structures resting on the ground or other horizontal surfaces. Furthermore, the term “pipe hanger” may encompass horizontal strut channel systems, gang-run pipe racks, and multi-pipe support frames. In such ‘rack’ applications, the pipe hanger support may provide a flat or semi-flat bottom profile (via an insulation shield or the insulating medium itself) adapted to rest securely on the top flanges of a strut channel. This may allow for high-density piping configurations where multiple pipes are supported in parallel on a single structural member, e.g., in rack application embodiments. Additionally, the term may include lateral support systems that secure pipes from the side, such as wall-mounted brackets, pipe clamps attached to vertical surfaces, and/or guide supports integrated into structural frameworks. These various forms of pipe hangers may be used individually or in combination to provide appropriate support and positioning for pipes in diverse installation scenarios, including industrial, commercial, and residential applications. In this manner, the term “pipe hanger support” may also be understood to include aspects of the present teachings where a pipe and its insulation is protected from any structure used to maintain a position of a pipe, such as hanging supports, bottom-up supports, lateral supports, and the like. Thus, although this disclosure may emphasize vertical pipe hangers for hanging pipe from above, others configurations are also or instead possible while still receiving benefits provided by aspects of the present teachings.

It will be understood that the term “insulating medium” or the like as used herein may generally refer to a substantially continuous body of material designed to provide thermal insulation and protection for pipes. More specifically, an insulating medium according to an aspect of the present teachings may be formed from weatherproof and durable materials such as rubber, capable of withstanding a range of operating temperatures (e.g., from -57 degrees Celsius (about -70 degrees Fahrenheit) to 125 degrees Celsius (about 257 degrees Fahrenheit)). The insulating medium may be flexible enough to be wrapped around a pipe while maintaining its insulating properties and structural integrity. The insulating medium may also or instead be flexible enough to be disposed in a substantially flat configuration, e.g., for shipping, storage, and the like.

It will be understood that the term “continuous” as used herein may generally refer to an uninterrupted or unbroken form, structure, or sequence. In the context of pipe hanger supports, a continuous body may include a single piece of material that extends without gaps or joints along its length. However, the term may also or instead encompass structures formed from multiple pieces that are joined or bonded together in a manner that creates a functionally continuous body. For example, a continuous insulating medium may be created by securely connecting separate sections of insulation material, provided that the resulting assembly maintains consistent insulating properties and structural integrity throughout its length. This definition of continuous may allow for practical manufacturing and installation considerations while preserving the essential characteristics of an uninterrupted insulating barrier around a pipe.

It will be understood that the term “support insert” or the like as used herein may generally refer to a rigid or semi-rigid component embedded within an insulating medium of a pipe hanger support. Support inserts may be made from materials such as high-density molded fiberglass, phenolic foam, polymers, wood, mica (e.g., a mica plate), calcium silicate, and the like. These inserts may be positioned at specific locations within an insulating medium to provide additional structural support and prevent compression of insulation at pipe hanger contact points. Support inserts may be wholly embedded within an insulating medium, where they are isolated from an external environment.

It will be understood that the term “fastener” or the like as used herein may generally refer to a mechanism or component used to secure the ends of an insulating medium around a pipe. More specifically, a “first fastener” may refer to a releasable coupling mechanism, such as a hook and loop component, that allows for temporary attachment and easy adjustment during installation. A “second fastener” may refer to a permanent coupling mechanism, such as an adhesive tape or self-sealing tape, designed to create a lasting, weatherproof seal once a pipe hanger support is properly positioned.

It will be understood that the term “insulation shield” or the like as used herein may generally refer to a protective component placed between a pipe hanger support and a load-bearing member of a pipe hanger. The insulation shield may have a curved or concave profile to match the pipe’s contour and may be made of materials such as metal. Its primary function may be to distribute the weight of the pipe evenly and prevent direct contact between the pipe hanger and the insulation, thereby reducing the risk of insulation compression or damage. An insulation shield may be disposed partially about a pipe hanger support (e.g., about 180-degrees) or fully about a pipe hanger support (e.g., about 360-degrees).

It will be understood that the term “vapor barrier” or the like as used herein may generally refer to a protective layer or property of an insulating medium that prevents or significantly reduces the transmission of water vapor through the material. In the context of pipe hanger supports, the vapor barrier may be maintained on both the top and bottom surfaces of the insulating medium, even with the inclusion of embedded support inserts, to ensure consistent protection against moisture infiltration along the entire length of the insulated pipe.

It will be understood that the term “weatherproof” or the like as used herein may generally refer to the ability of a material or component to resist degradation or loss of functionality when exposed to various environmental conditions such as moisture, humidity, temperature fluctuations, and UV radiation. In the context of pipe hanger supports, weatherproof materials may be used to ensure long-term durability and effectiveness of the insulation system, particularly in outdoor or high-humidity applications. Also or instead, weatherproof materials may be used to prevent degradation of materials if exposed to the elements on a job site, during transport, or the like, e.g., prior to installation.

It will be understood that the term “chilled water pipe” as used herein may generally refer to a pipe used in HVAC systems or industrial processes to transport water that has been cooled to temperatures significantly below ambient conditions, typically for cooling or heat exchange purposes. These pipes often require specialized insulation to prevent condensation, maintain energy efficiency, and ensure proper system performance.

It will be understood that the term “heat trace cable” or the like as used herein may generally refer to an electrical heating element installed along the length of a pipe to maintain or raise its temperature. In the context of pipe hanger supports, provisions may be made to accommodate heat trace cables between the pipe and the insulating medium, allowing for temperature control while maintaining the integrity of the insulation system.

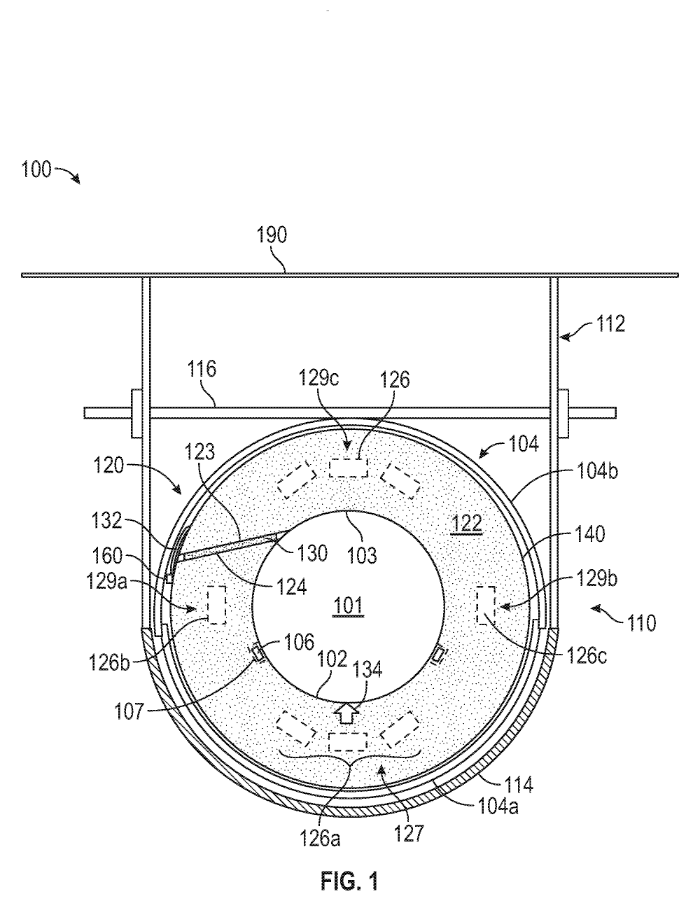

FIG. 1 illustrates a system 100 for safeguarding insulation disposed about a pipe 101 at a hanger location, according to a representative example. The system 100 may include a pipe 101 having a circumference with a top end 103 and a bottom end 102. A pipe hanger 110 may be configured to support the pipe 101. The pipe hanger 110 may include a hanger body 112 adapted to suspend from a support structure 190, such as a building component (e.g., beam, joist, etc.) or similar. A load-bearing member 114 may be coupled to the hanger body 112, where the load-bearing member 114 may be structurally configured to receive and support the pipe 101 along the bottom end 102 thereof (e.g., the load-bearing member 114 may be a supporting member). In certain aspects, the load-bearing member 114 may include a concave profile to better accommodate the curvature of the pipe 101.

An insulation shield 104 may be adapted for placement along the load-bearing member 114, between the load-bearing member 114 and the bottom end 102 of the pipe 101. The insulation shield 104 may include a curved profile, and in some implementations, may be formed from a curved metal sheet to provide additional protection and support. In some aspects, the insulation shield 104 may be part of the pipe hanger support 120—e.g., integral with the pipe hanger support 120 and/or coupled thereto. For example, certain aspects may include a low gauge sheet metal that is coupled to (e.g., adhered, screwed onto, or otherwise secured) a surface of the pipe hanger support 120. In this manner, some aspects may include a pre-installed insulation shield 104.

The support 120 may include a first insulation shield 104a positioned adjacent to a first location 127 along the length of the insulating medium 122 for disposition between the pipe and a portion of the pipe hanger 110. The support 120 may further include a second insulation shield 104b positioned opposite the first location 127. The first insulation shield 104a and the second insulation shield 104b may be configured to overlap to form a substantially continuous protective encasement around the insulating medium 122. One or more of the first insulation shield 104a and the second insulation shield 104b may be formed from a metal material. In certain aspects, one or more of the first insulation shield 104a and the second insulation shield 104b may be formed from 16-gauge galvanized steel, providing a robust layer of protection against high compressive loads, impacts, and environmental debris.

In an example aspect, the support 120 may include a first insulation shield 104a that is permanently coupled to the support 120, such as by adhesive bonding, mechanical fasteners, or integration during manufacturing. The support 120 may further include a second insulation shield 104b that is removable and replaceable onto the support 120. In such configurations, the support 120 may be shipped with both the first insulation shield 104a and the second insulation shield 104b enveloping the insulating medium 122 in a substantially cylindrical configuration. During installation, the second insulation shield 104b may be removed from the support 120, allowing the insulating medium 122 to be opened and wrapped about the pipe 101. Once the insulating medium 122 is properly positioned and engaged with the pipe 101, the second insulation shield 104b may be placed back onto the support 120 to complete the protective encasement around the insulating medium 122. In certain aspects, the second insulation shield 104b may then be permanently affixed to the support 120, such as by welding, adhesive bonding, mechanical fasteners, or sealing tape, to create a secure and continuous protective barrier. This configuration may simplify installation by allowing the support 120 to be shipped in a pre-assembled state while still permitting field installation around existing pipes.

As described herein, the present teachings may include a pipe hanger support 120. In general, the support 120 may be configured to protect insulation disposed about the pipe 101 at locations where pipe hangers or other support structures contact the pipe, preventing crushing or other damage that could compromise insulation integrity. The pipe hanger support 120 may include an insulating medium 122 formed as a continuous body defining a length between a first end 123 and a second end 124. The length of the insulating medium 122 may be selected to substantially envelop the circumference of the pipe 101 when the support 120 is wrapped about the pipe.

The pipe hanger support 120 in the system 100 may serve multiple purposes to enhance the overall performance and longevity of the insulated pipe installation. It may act as a protective barrier between the pipe 101 and the load-bearing member 114 of the pipe hanger 110, helping to distribute the weight of the pipe 101 more evenly and reduce localized stress on the insulation. The pipe hanger support 120 may also help maintain the thermal efficiency of the insulation by preventing compression at the hanger location, which could otherwise create thermal bridges and reduce the insulation’s effectiveness. Additionally, the pipe hanger support 120 may provide a weatherproof barrier that helps protect the insulation from moisture infiltration and environmental degradation, particularly in outdoor or high-humidity installations. And, by incorporating both temporary and permanent fastening mechanisms as described herein, the pipe hanger support 120 may allow for easier installation and adjustment while ensuring a secure long-term fit around the pipe 101.

It will be understood that the insulation being protected by the pipe hanger support 120 may be integral therewith—e.g., it may include the insulating medium 122—and/or the pipe hanger support 120 may surround other insulating materials. That is, the pipe hanger support 120 may provide protection for insulation in multiple ways. In some aspects, the insulating medium 122 of the pipe hanger support 120 may itself serve as the primary insulation for the pipe 101, e.g., at least in the location of the pipe hanger 110. The insulating medium 122 may be designed with thermal properties suitable for maintaining desired temperature conditions and preventing heat transfer between the pipe 101 and its surroundings. Additionally or alternatively, the pipe hanger support 120 may be configured to work in conjunction with other insulating materials. In such configurations, the pipe hanger support 120 may surround or envelop pre-existing insulation applied directly to the pipe 101. This arrangement may allow the pipe hanger support 120 to provide an additional layer of protection and support for the underlying insulation, particularly at critical hanger locations where compression forces are most significant.

In some implementations, the pipe hanger support 120 may incorporate a composite design where different layers or sections of the insulating medium 122 have varying thermal and mechanical properties. This may allow for optimized performance in different areas of the support, such as enhanced compressive strength near the support inserts 126 and improved thermal resistance in other areas. The pipe hanger support 120 may also or instead be designed to accommodate various thicknesses and types of underlying insulation. The flexibility of the insulating medium 122 may allow it to conform to different insulation profiles while still providing effective protection and support at the hanger location. In certain aspects, the pipe hanger support 120 may include provisions for creating a seamless transition between itself and adjacent insulation sections along the pipe. This may involve tapered edges or overlapping designs that help maintain continuous insulation coverage and minimize thermal bridging at the interfaces between different insulation components.

The insulating medium 122 of the pipe hanger support 120 may be formed from weatherproof and durable materials such as rubber or a similar elastomeric material that may provide flexibility, durability, and resistance to environmental conditions. In an aspect, the material of the insulating medium 122 may be capable of withstanding a range of operating temperatures, for example from -57 degrees Celsius to 125 degrees Celsius. In some aspects, the insulating medium 122 may be formed from a closed cell EPDM (Ethylene Propylene Diene Monomer) based elastomeric foam—this material selection may provide specific advantages for the pipe hanger support 120, including plenum rating compliance and enhanced durability. In an aspect, the EPDM-based insulating medium 122 may be structurally configured to maintain its flexibility and thermal integrity across a continuous service temperature range of approximately -22°F to 248°F (-30°C to 120°C). Furthermore, the EPDM composition may ensure that the support maintains high resistance to weathering, UV exposure, and ozone, making it suitable for both indoor and outdoor applications. In some aspects, the insulating medium 122 may be formed from a sheet of rubber or a roll of rubber material. That is, the insulating medium 122 may be manufactured as a flat sheet or roll, without pre-curvature. This configuration may offer advantages for shipping and storage, particularly for large pipe components. The flat form factor may allow for more efficient packing and transportation, reducing shipping costs and storage space requirements. Moreover, a flexible material such as rubber or the like may be lighter than other materials such as calcium silicate, further reducing shipping costs. In an aspect, the insulating medium 122 may lack calcium silicate, potentially offering advantages in terms of durability and weatherproofing compared to traditional calcium silicate insulating systems. Additionally, the absence of pre-curvature may enhance the versatility of the insulating medium 122, allowing it to be easily adapted to pipes of various diameters. When installation is required, the flexibility of the material may permit on-site shaping to conform to the specific pipe circumference, potentially simplifying the installation process and reducing the need for multiple pre-curved sizes to be kept in inventory. The rubber composition may provide flexibility, allowing the insulating medium 122 to be easily wrapped around the pipe 101 while maintaining its insulating properties and structural integrity.

The insulating medium 122 may have a width of about 14 inches (35.56 cm) in some implementations (i.e., where the width corresponds to the dimension of the insulating medium 122 along the length of the pipe 101), which may be suitable for various pipe sizes and insulation thicknesses. Other widths are also or instead possible, including larger or smaller widths. For example, the insulating medium 122 may have a width of about 24 inches (60.96 cm), about 18 inches (45.72 cm), about 12inches (30.48 cm), about 10 inches (25.4 cm), about 8 inches (20.32 cm), about 6 inches (15.24 cm), about 4 inches (10.16 cm), and so forth. The thickness of the insulating medium 122 may range from about 1 inch (2.54 cm) to about 2 inches (5.08 cm), inclusive, providing sufficient insulation while maintaining flexibility for wrapping about pipes of various diameters. Other thicknesses are also or instead possible, including larger or smaller thicknesses.

In some aspects, the insulating medium 122 may incorporate a vapor barrier on at least one of its surfaces, e.g., on either one, or both of its top and bottom surfaces (see, e.g., the vapor barrier 440 of FIG. 4). This vapor barrier may be uncompromised by the inclusion of the embedded support inserts 126, ensuring consistent protection against moisture infiltration along the entire length of the insulated pipe 101. The vapor barrier may be achieved through various means. In some cases, the insulating material itself may possess inherent vapor barrier properties. For example, a rubber material may have a low permeability to water vapor. By way of further example, closed-cell elastomeric foam materials may naturally resist moisture vapor transmission due to their cellular structure. Certain types of polyethylene foam or cross-linked polyethylene (XLPE) may also provide effective vapor barrier characteristics without additional treatments and/or mastics or other coatings. In other implementations, the vapor barrier may be formed by applying specific substances or treatments and/or mastics to the insulating medium 122. By way of example, a thin layer of aluminum foil may be laminated to the surface of the insulating material, creating a highly effective vapor barrier. Alternatively, metalized films or polymer-based membranes may be adhered to the insulating medium 122 to enhance its vapor barrier properties. Some insulating mediums 122 may also or instead be coated with specialized vapor barrier paints or sealants. These coatings may include products based on epoxy resins, polyurethane, or other polymeric materials designed to create a moisture-impermeable layer on the surface of the insulating medium 122. In certain aspects, the vapor barrier may be achieved through the application of spray-on coatings. These may include elastomeric coatings or liquid-applied membranes that form a substantially continuous, seamless vapor barrier when cured. Such coatings may be particularly useful for creating vapor barriers on complex shapes or in areas where traditional sheet materials may be difficult to apply. The vapor barrier may also or instead be integrated into the insulating medium 122 through the use of multi-layer composite materials. For instance, a layer of polyethylene or polypropylene film may be sandwiched between layers of insulating material during the manufacturing process, creating an integral vapor barrier throughout the insulating medium 122. In some implementations, the vapor barrier properties of the insulating medium 122 may be enhanced through the application of water-repellent treatments or impregnations. Silicone-based or fluoropolymer treatments may be used to create a hydrophobic surface on the insulating medium 122, further reducing its tendency to absorb or transmit water vapor.

The material used to form the insulating medium 122 may lack calcium silicate, potentially offering advantages in terms of durability and weatherproofing compared to traditional calcium silicate insulating systems. However, it will be understood that, in some aspects, the support inserts 126 described herein may include calcium silicate, although the insulating medium 122 surrounding such inserts may lack calcium silicate. The weatherproof nature of the insulating medium 122 may allow it to resist degradation when exposed to various environmental conditions such as moisture, humidity, temperature fluctuations, and UV radiation. That is, the insulating medium 122 may serve to conceal and protect the support inserts 126 embedded therein, shielding the inserts from direct exposure to environmental factors and mechanical damage. This protective encapsulation may enable the use of a wider variety of materials for the support inserts 126, including materials that might otherwise be unsuitable for direct environmental exposure, such as calcium silicate, wood, or other materials that may be susceptible to moisture absorption or degradation. By isolating the support inserts 126 within the weatherproof insulating medium 122, the overall pipe hanger support 120 may benefit from the structural properties of the insert materials while the insulating medium 122 provides the necessary environmental protection.

In some implementations, the insulating medium 122 may include one or more markings 134 on its surface. These markings 134 may serve as alignment guides for placement, e.g., at the bottom end 102 or top end 103 of the pipe 101, and/or may indicate the location of embedded support inserts 126. The markings 134 may be printed, embossed, or otherwise permanently applied to the surface of the insulating medium 122 during manufacturing. In certain aspects, the markings 134 may include directional indicators such as arrows, lines, and/or text that guide proper orientation during installation. For example, markings 134 may include text labels such as “TOP” and/or “BOTTOM” to ensure the pipe hanger support 120 is positioned correctly relative to the pipe 101 and pipe hanger 110. The markings 134 may also or instead include measurement indicators or reference points to assist installers in properly sizing or positioning the pipe hanger support 120 for pipes of different diameters. In some implementations, the markings 134 may be color-coded to indicate different sections or functions of the pipe hanger support 120, for example, a first color may be used to highlight areas containing support inserts 126 and a second color may be used for areas without inserts. Additionally, or instead, the markings 134 may include product information such as manufacturer details, material specifications, temperature ratings, and/or installation instructions. Such markings 134 may be located directly on the insulating medium 122 for easy reference during installation and maintenance. These various marking types can significantly enhance the usability of the pipe hanger support 120 by reducing installation errors and ensuring optimal positioning for maximum insulation protection.

The pipe hanger support 120 may include one or more support inserts 126 embedded within the continuous body of the insulating medium 122, e.g., at predetermined locations. The support inserts 126 may be embedded in the insulating medium 122, e.g., by removing material of the insulating medium 122 to form a void, and placing at least one of the one or more support inserts within the void. Also or instead, the insulating medium 122 may be formed around the support inserts 126, e.g., by molding the insulating material directly around the support inserts 126 during an injection molding or compression molding process, or by assembling the insulating medium 122 from multiple sections that are bonded together with the support inserts 126 positioned at the interfaces.

The support inserts 126 may serve any of multiple purposes within the pipe hanger support system 100. In some aspects, the support inserts 126 may provide localized reinforcement to the insulating medium 122, enhancing its ability to withstand compressive forces at critical contact points between the pipe 101 and the pipe hanger 110. The support inserts 126 may also or instead help distribute the weight of the pipe 101 more evenly across the insulating medium 122, potentially reducing the risk of insulation being crushed or deformed at the hanger location. In certain implementations, the support inserts 126 may act as thermally consistent elements, helping to maintain consistent insulation performance across the entire pipe hanger support 120 (and therefore around the entire circumference of the pipe 101). The support inserts 126 may also or instead contribute to the overall structural integrity of the pipe hanger support 120, allowing it to maintain its shape and function over extended periods of use and under various environmental conditions. Additionally, the support inserts 126 may facilitate easier installation and alignment of the pipe hanger support 120 by providing tactile or visual cues for proper positioning around the pipe. In some cases, the support inserts 126 may enhance the durability and longevity of the pipe hanger support 120, potentially extending its service life in demanding industrial or commercial applications.

The support inserts 126 may serve a primary function of preventing crushing of the insulating medium 122 at stress locations where compressive forces are concentrated. At pipe hanger locations, the weight of the pipe 101 and its contents creates significant downward pressure that is transmitted through the insulating medium 122 to the load-bearing member 114 of the pipe hanger 110. Without adequate reinforcement, this concentrated loading may compress or crush the insulating medium 122, compromising its thermal properties and structural integrity. The support inserts 126, being formed from materials with higher compressive strength than the surrounding insulating medium 122, may resist these compressive forces and maintain the dimensional stability of the insulating medium 122 at critical contact points. By embedding the support inserts 126 at predetermined locations corresponding to areas of anticipated stress, the pipe hanger support 120 may effectively transfer loads through the rigid inserts rather than through the more compressible insulating material. This load transfer mechanism may preserve the insulating properties of the insulating medium 122 by preventing the reduction in thickness that would otherwise occur under sustained compressive loading. The support inserts 126 may thus function as structural reinforcement elements that protect the insulating medium 122 from the crushing forces inherent to pipe hanger applications.

The plurality of support inserts may comprise at least three primary support inserts 126a positioned at the first location 127 along the length of the insulating medium 122. The first location 127 may be selected to be adjacent to at least one of a bottom end or a top end of the pipe when the insulating medium 122 is wrapped about the pipe 101. In certain aspects, the primary support inserts 126a may be disposed at each of a top end and a bottom end of the support 120 when disposed about a pipe 101 or the like. The primary support inserts 126a may be arranged in a row at the first location 127, where the primary support inserts 126a are spaced apart with a predetermined spacing. The predetermined spacing may be selected to distribute compressive forces substantially evenly across the insulating medium 122 at the first location 127, potentially extending the service life of both the support 120 and the underlying insulation by preventing localized stress concentrations. The predetermined spacing may also or instead be selected to maintain sufficient flexibility in the insulating medium 122 such that the pipe hanger support 120 can be wrapped about the circumference of the pipe 101 during installation. By positioning the primary support inserts 126a with adequate gaps therebetween, the insulating medium 122 may flex at the regions between adjacent inserts, allowing the otherwise rigid insert sections to conform to the curved profile of the pipe 101.

The plurality of support inserts may further comprise a first side support insert 126b positioned at a second location 129a along the length of the insulating medium 122. The second location 129a may be selected to be adjacent to a first side of the pipe when the insulating medium 122 is wrapped about the pipe (e.g., at a 9 o’clock position). The plurality of support inserts may also comprise a second side support insert 126c positioned at a third location 129b along the length of the insulating medium 122. The third location 129b may be selected to be adjacent to a second side of the pipe when the insulating medium 122 is wrapped about the pipe (e.g., at a 3 o’clock position). This configuration of support inserts at multiple locations around the circumference of the insulating medium 122 may provide comprehensive protection for the insulation at various contact points where compressive forces from pipe hangers or other support structures might otherwise compromise insulation integrity. Other locations for the support inserts are also or instead possible. In certain implementations, the pipe hanger support 120 may include support inserts 126 positioned at multiple locations distributed substantially around the entire circumference of the insulating medium 122. For example, support inserts 126 may be embedded at four or more locations corresponding to approximately the 12 o’clock, 3 o’clock, 6 o’clock, and 9 o’clock positions when the insulating medium 122 is wrapped about the pipe 101. This circumferential distribution of support inserts 126 may provide comprehensive protection against compressive forces from various directions, which may be particularly beneficial in applications where the pipe hanger support 120 interfaces with multiple components of a pipe hanger assembly or where lateral forces may be present in addition to vertical loading. The support inserts 126 at each circumferential position may be sized and spaced according to the anticipated loading conditions at that location, with larger or more closely spaced inserts positioned at locations experiencing greater compressive forces.

The support inserts 126 may be made from a variety of materials and structured in different ways to enhance the performance of the pipe hanger support 120. In some implementations, the support inserts 126 may be composed of high-density polyethylene (HDPE), which offers a combination of strength, durability, and chemical resistance. The HDPE inserts may be molded or machined to fit precisely within the insulating medium 122. In other aspects, the support inserts 126 may be fabricated from reinforced plastics or composite materials. For example, glass fiber-reinforced polymers may provide high strength-to-weight ratios and excellent resistance to environmental factors. Such composite inserts may be manufactured through processes such as pultrusion or compression molding to achieve desired shapes and mechanical properties. The support inserts 126 may also or instead be constructed from metal materials in some implementations. Aluminum alloys, for instance, may offer advantageous strength and corrosion resistance while remaining relatively lightweight. Stainless steel inserts may be used in applications requiring relatively high load-bearing capacity or exposure to harsh environments. In some aspects, the plurality of support inserts may include at least one of: high-density molded fiberglass, mica, calcium silicate, phenolic foam, a polymer, wood, combinations thereof, and the like.

In some aspects, the support inserts 126 may be constructed from a material such as Marinite P™, a calcium silicate product made and trademarked by BNZ Materials, Inc. of Delaware, United States. In some instances, the support inserts 126 may be made wholly or partially from calcium silicate (e.g., calcium silicate with inert fillers and reinforcing agents, providing structural strength and thermal insulation properties in a single material). The support inserts 126 may provide high compressive strength, allowing them to effectively distribute the load of the pipe and resist deformation under pressure. The support inserts 126 may also or instead include a layered structure, which may contribute to an ability to withstand mechanical stress, potentially enhancing the overall durability of the pipe hanger support 120. The thermal properties of support inserts 126 may be particularly beneficial in pipe insulation applications. The support inserts 126 may help maintain the thermal efficiency of the insulating medium 122 by minimizing heat transfer at the support points. This may be especially advantageous in systems with extreme temperature differentials or in applications where maintaining consistent insulation performance is critical. In some aspects, the support inserts 126 may be treated or coated to enhance their moisture resistance and durability. This treatment may help the support inserts 126 withstand exposure to various environmental conditions and extend the service life of the pipe hanger support 120. The use of support inserts 126 may also contribute to the overall fire resistance of the pipe hanger support 120. In certain implementations, the support inserts 126 may be combined with other materials to create composites. For example, support inserts 126 may be laminated with reinforcing materials or encapsulated within a protective polymer matrix, potentially enhancing their strength and durability while maintaining their beneficial insulation properties.

In terms of structure, the support inserts 126 may be designed with various profiles and geometries to optimize their performance within the pipe hanger support 120. In some cases, the support inserts 126 are simply blocks of material. Also or instead, the inserts may feature a curved or contoured surface that matches the curvature of the pipe 101, allowing for better load distribution and support. The inserts may also or instead incorporate ribbed or honeycomb internal structures to enhance strength while minimizing weight. The support inserts 126 may be structured with tapered edges or graduated thicknesses in some implementations. This design may help create a smooth transition between the inserts and the surrounding insulating medium 122, reducing stress concentrations and improving overall load distribution.

The support inserts 126 may be designed with various shapes and thicknesses to optimize their performance within the pipe hanger support 120. In some aspects, the support inserts 126 may have rectangular, circular, oval, or custom-shaped profiles to best accommodate the specific load distribution requirements of different pipe sizes and weights. The thickness of the support inserts 126 may also vary depending on the application. In certain implementations, the support inserts 126 may be thinner than the insulating medium 122 and fully embedded within it, providing additional support while maintaining a smooth outer surface. In other cases, the support inserts 126 may have a thickness equal to that of the insulating medium 122, allowing their surfaces to align flush with the insulating medium’s surface. Further, some configurations may feature support inserts 126 that are thicker than the insulating medium 122, with surfaces partially exposed to provide direct or indirect contact with the pipe 101 or the load-bearing member 114 of the pipe hanger 110.

In certain aspects, the support inserts 126 may be engineered with interlocking features or attachment points that allow them to securely anchor within the insulating medium 122. This may involve the use of protrusions, grooves, or other mechanical interfaces that enhance the bond between the inserts and the surrounding material. The support inserts 126 may also or instead be structured with internal channels or voids in some implementations. These features may serve multiple purposes, such as reducing weight, improving thermal performance, or accommodating additional components like heat tracing elements or sensor wiring. In some cases, the support inserts 126 may be designed as modular components that can be combined or arranged in various configurations within the insulating medium 122. This modular approach may allow for customization of the pipe hanger support 120 to suit different pipe sizes, load requirements, or installation scenarios.

The structure of the support inserts 126 may incorporate surface textures or treatments that enhance their interaction with the insulating medium 122. For example, the inserts may feature a roughened or patterned surface that may improve adhesion and/or mechanical bonding with the surrounding material.

To enhance the structural integrity of the pipe hanger support 120, the support inserts 126 may be reinforced along the insulating medium 122. This reinforcement may involve the use of additional materials or structural elements integrated into the insulating medium 122 around one or more portions of the support inserts 126. For example, in some implementations, a reinforcing mesh or fabric may be embedded or otherwise engaged on or within the insulating medium 122 surrounding the support inserts 126, helping to distribute loads more evenly and/or prevent the inserts from weakening the insulating medium 122 in that area. In other aspects, the edges of the support inserts 126 may be designed with interlocking features that mechanically engage with the surrounding insulating medium 122, reducing the risk of the inserts dropping out or shifting position over time. Additionally, in some cases, the insulating medium 122 may be formulated with varying densities or compositions in the areas surrounding the support inserts 126, providing enhanced bonding and/or load transfer between the support inserts 126 and the insulating medium 122.

In some implementations, special consideration may be given to maintaining the vapor barrier integrity of the insulating medium 122 when incorporating support inserts 126. This consideration may be particularly salient in support inserts 126 having a thickness that may otherwise compromise a vapor barrier of the insulating medium 122. That is, for support inserts 126 that are fully embedded within the insulating medium 122, the vapor barrier may naturally remain intact. However, in cases where the support inserts 126 are as thick as or thicker than the insulating medium 122, additional sealing measures may be employed. For instance, a flexible sealant or gasket material may be applied around the edges of the support inserts 126 to create a weatherproof seal with the surrounding insulating medium 122, or otherwise to provide a reinforcement in this region. In some aspects, the support inserts 126 may be encapsulated in a thin layer of vapor barrier material before being integrated into the insulating medium 122, ensuring continuity of the vapor barrier even if the inserts are exposed. For thicker support inserts 126 that protrude from the surface, an overlapping flap of vapor barrier material from the insulating medium 122 may be designed to fold over and seal against the exposed surface of the insert, maintaining a continuous vapor barrier across the entire pipe hanger support 120. One or more materials may also or instead be placed over regions where support inserts 126 are present within the insulating medium 122.

The first location 127 of the support inserts 126 may be selected such that the insulating medium 122, when wrapped about the pipe 101, envelops the pipe 101 with the one or more support inserts 126 disposed adjacent to the bottom end 102 of the pipe 101 for positioning between the bottom end 102 of the pipe 101 and the load-bearing member 114. Also or instead, a fourth location 129c along the length of the insulating medium 122 may be provided for additional support inserts 126, which may be positioned adjacent to the top end 103 of the pipe 101 when the insulating medium 122 is wrapped around the pipe 101. This configuration may provide protection against a top portion 116 of the pipe hanger 110, ensuring comprehensive insulation protection throughout the pipe hanger location. Other locations for the one or more support inserts 126 are also or instead possible, including along sides of the pipe hanger support 120. In general, the support inserts 126 may be advantageously disposed within the insulating medium 122 in one or more locations where a pipe 101 will be supported, and where insulation is susceptible to damage from such support.

As described above, a flexibility of the insulating medium 122 and a predetermined spacing 128 between the one or more support inserts 126 may permit the insulating medium 122 with the one or more support inserts 126 embedded therein to be wrapped about the circumference of the pipe 101. The predetermined spacing 128 may include a spacing of at least 1 inch (2.54 cm) apart. Other spacing is also or instead possible. Additionally, in some aspects, this configuration may allow the insulating medium 122 with the one or more support inserts 126 embedded therein to be stored substantially flat when not in use.

The pipe hanger support 120 may incorporate fasteners to facilitate secure installation and/or long-term performance. Fasteners may play a crucial role in the installation process, allowing for initial positioning and adjustment of the pipe hanger support 120 around the pipe 101, as well as providing a means for permanent attachment once the optimal position is achieved. The use of fasteners may enable installers to work efficiently, potentially reducing installation time and improving the overall quality of the system 100.

In some implementations, the pipe hanger support 120 may utilize multiple types of fasteners, each serving a specific purpose during different stages of installation and use. For example, temporary fasteners may allow for quick attachment and repositioning during the initial fitting process (e.g., to accommodate the addition of one or more pipeline components 106 or otherwise), while permanent fasteners may provide a lasting, weatherproof seal once the final position is determined (and may not, e.g., be configured for non-destructive removal of the fastener or decoupling of fastened component).

The fastening system of the pipe hanger support 120 may be designed to accommodate various pipe sizes and installation conditions. It may allow for some degree of adjustability to account for variations in pipe diameter or to compensate for any misalignment during the installation process. The fasteners may also be selected to withstand the environmental conditions and operational stresses that the pipe hanger support 120 may encounter throughout its service life. In some aspects, fasteners may be integrated directly into the insulating medium 122, potentially simplifying the installation process and reducing the need for additional components. The design and placement of these fasteners may take into account factors such as ease of access, resistance to accidental disengagement, and compatibility with the overall thermal and mechanical properties of the pipe hanger support 120.

Each of the first end 123 and the second end 124 may include a mating surface for coupling therebetween. In certain aspects, the mating surface of one or more of the first end 123 and the second end 124 may include an angled or beveled edge that creates complementary mating surfaces when the first end 123 and the second end 124 are coupled. This angled or beveled configuration may provide improved contact area and reduce stress concentrations at the joint, potentially enhancing the effectiveness of fasteners and sealing components disposed at the mating surfaces.

The support 120 may include a first fastener 130 disposed on the mating surface of at least one of the first end 123 and the second end 124 of the insulating medium 122. The first fastener 130 may be structurally configured to couple the first end 123 and the second end 124. In certain aspects, the first fastener 130 may comprise an adhesive component. The adhesive component may comprise a double-sided tape or similar adhesive strip formed directly on the mating surface of the insulating medium 122. The adhesive component may be pre-applied during manufacturing and protected by a release liner until installation, allowing an installer to peel away the liner and press the first end 123 against the second end 124 to create a secure bond. This configuration may provide a substantially airtight and robust seal without requiring extra tooling or field-applied adhesives, potentially simplifying the installation process.

The first fastener 130 may also or instead serve as a temporary fastener, allowing for adjustment of the pipe hanger support 120 during installation or maintenance. This temporary fastening mechanism may provide flexibility in positioning the support and facilitate the installation or adjustment of underlying components such as heat trace cables, sensors, communication components, and the like. In some aspects, hook and loop fasteners may be used as the first fastener 130 for the pipe hanger support 120. These hook and loop fasteners may allow for quick attachment and detachment, enabling installers to easily adjust the position of the pipe hanger support 120 around the pipe 101. The hook and loop components may be strategically placed on the first end 123 and/or the second end 124 of the insulating medium 122, allowing for secure yet reversible closure.

Other types of fasteners may also or instead be used for the first fastener 130. In some implementations, snap fasteners may be employed as temporary fasteners. Magnetic fasteners may also or instead be used as temporary fasteners in certain applications. These may include magnetic strips or discrete magnets embedded within the ends of the insulating medium 122. Magnetic fasteners may provide a strong hold while allowing for easy release and reattachment during installation or maintenance procedures. In some cases, elastic straps or bands may serve as temporary fasteners. These may be attached to one end of the insulating medium 122 and stretched around the pipe 101 to secure the other end. Elastic fasteners may accommodate slight variations in pipe diameter and allow for quick release when access to underlying components is needed. Removable adhesive strips may be another option for temporary fastening. These may include double-sided tape or adhesive patches that provide a strong hold but can be peeled off without leaving significant residue. In certain implementations, interlocking plastic tabs or clips may be used as temporary fasteners. These may be molded into or attached to the ends of the insulating medium 122, allowing for a secure connection that can be easily released by applying pressure or manipulating the tabs in a specific manner.

The support 120 may include a vapor barrier 140 disposed on an exterior surface of the insulating medium 122 and/or on an interior surface of the insulating medium 122. The vapor barrier 140 may extend continuously across the exterior and/or interior surface of the insulating medium 122, providing consistent protection against moisture infiltration along the entire length of the support 120. The vapor barrier 140 may be any as described herein, including sheeting materials, foil materials, membranes, coatings, or the like.

The pipe hanger support 120 may include one or more second fasteners 132, e.g., at least partially disposed on the vapor barrier 140. A second fastener 132 may be structurally configured to further couple the first end 123 and the second end 124 of the insulating medium 122. In certain aspects, the second fastener 132 may comprise a self-sealing lap tape. The self-sealing lap tape may be configured to overlay a location of the first fastener 130, providing an additional layer of sealing that enhances the weatherproofing and structural integrity of the closure. When used in conjunction with the adhesive-based first fastener 130, the second fastener 132 may provide redundant sealing that addresses both the inner and outer surfaces of the closure region. In an aspect, the second fastener 132 may provide a relatively permanent coupling compared to the first fastener 130, and may provide a secure and long-lasting installation of the pipe hanger support 120 around the pipe 101.

The second fastener 132 may include various types of permanent coupling mechanisms. For example, the second fastener 132 may include a tape component, such as a self-sealing tape or the like. Adhesive tapes with high bonding strength may be used to create a lasting seal between the ends of the insulating medium 122. These tapes may be designed to withstand temperature fluctuations, moisture exposure, and mechanical stress, ensuring the pipe hanger support 120 remains securely fastened throughout its service life.

In some implementations, the second fastener 132 may utilize a heat-activated bonding system. This may involve the application of a thermoplastic adhesive that becomes active when exposed to heat, creating a strong and permanent bond between the ends of the insulating medium 122. The heat activation process may be performed using portable heat guns or specialized tools, allowing for on-site customization and precise control over the bonding process. Another option for the second fastener 132 may be a chemical bonding system. This may involve the use of two-part epoxy adhesives or cyanoacrylate-based products that create a strong molecular bond between the ends of the insulating medium 122. These chemical fasteners may offer advantages in terms of rapid curing times and resistance to environmental factors such as moisture and temperature variations. In some cases, the second fastener 132 may incorporate mechanical fastening elements, e.g., in combination with adhesive systems. For instance, interlocking zipper-like structures may be integrated into the ends of the insulating medium 122, with an adhesive sealant applied to ensure a weatherproof closure. This hybrid approach may provide both mechanical strength and environmental sealing properties.

The use of permanent fasteners in the pipe hanger support 120 may offer several advantages. For example, a secure and lasting closure may help maintain the integrity of the system 100 over extended periods, potentially reducing maintenance requirements and improving overall energy efficiency. The permanent seal may also enhance the weatherproofing capabilities of the pipe hanger support 120, helping to prevent moisture ingress and protect the underlying insulation/piping from degradation. In some implementations, the second fastener 132 may be designed with tamper-evident features. This may include breakaway tabs or color-changing indicators that provide visual confirmation of a properly sealed closure. Such features may be beneficial in applications where regular inspections are required or where unauthorized access to the insulation system needs to be detected. The permanent fastening system may also contribute to the overall structural integrity of the pipe hanger support 120. By creating a continuous, uninterrupted insulation structure around the pipe 101, the second fastener 132 may help distribute loads evenly and reduce stress concentrations that could potentially compromise the insulation performance. In certain aspects, the second fastener 132 may be engineered to accommodate thermal expansion and contraction of the pipe hanger support 120. This may involve the use of elastomeric adhesives or fastening systems with built-in flexibility, allowing the closure to maintain its seal even as the insulation material expands or contracts due to temperature changes. The design of the second fastener 132 may also take into account ease of installation in challenging environments. For instance, peel-and-stick adhesive systems or pre-applied adhesive strips protected by removable backing may allow for quick and clean installation in confined spaces or overhead applications, potentially reducing installation time and improving worker safety.

The dual fastening system employed in an aspect of the pipe hanger support 120 may offer several advantages in terms of installation flexibility and long-term performance. The use of both temporary and permanent fasteners may allow installers to easily position and adjust the support during initial placement, while also providing a secure and lasting seal once the optimal configuration is achieved. This approach may be particularly beneficial in complex piping systems or confined spaces where precise alignment is crucial. Furthermore, the combination of fastening mechanisms may enhance the overall reliability and adaptability of the pipe hanger support 120. The temporary fastener may facilitate maintenance procedures by allowing quick access to underlying components without compromising the integrity of the permanent seal. Meanwhile, the permanent fastener may provide a weatherproof barrier and structural continuity, potentially improving the insulation system’s resistance to environmental factors and mechanical stresses over time. This dual system may also accommodate a wider range of installation scenarios and pipe sizes, potentially reducing the need for multiple specialized support designs.

The support 120 may include a breakaway seam 160 disposed along the vapor barrier 140. The breakaway seam 160 may comprise a breakable connection between the first end 123 and the second end 124 that permits the support 120 to be shipped in a substantially cylindrical configuration and opened for installation about the pipe. The breakaway seam 160 may be positioned along a side of the support 120 disposed away from the primary support inserts 126a at the first location 127. For example, the breakaway seam 160 may be offset about the center of the support 120 from the first location 127 by about 90 degrees, about 45 degrees, about 180 degrees, or by another amount. This placement may allow an installer to separate the ends without disturbing the structural reinforcement provided by the embedded support inserts. The breakaway seam 160 may be formed as a perforated line, a scored or otherwise frangible region, or a weakened material section configured to maintain structural continuity during shipping and storage while permitting easy separation when installation is desired.

The support 120 may include a marking 134 on the insulating medium 122. The marking 134 may indicate at least one of: an alignment guide for placement at one or more of the bottom end of the pipe and the top end of the pipe, and a location of at least one of the plurality of support inserts. The marking 134 may assist installers in properly positioning the support 120 around a pipe to ensure optimal load distribution and protection at critical contact points.

In an example installation sequence for a support 120 shipped in a substantially cylindrical configuration, an installer may first remove the second insulation shield 104b from the exterior of the support 120 to access the breakaway seam 160. The installer may then detach the breakaway seam 160 by tearing along the perforated line or scored region, thereby separating the first end 123 from the second end 124 and opening the cylindrical structure. The opened support 120 may then be wrapped about the pipe 101 at the hanger location, with the installer using the marking 134 on the insulating medium 122 to properly align the primary support inserts 126a adjacent to the bottom end 102 of the pipe 101. Once aligned, the installer may engage the first fastener 130 to temporarily couple the first end 123 and the second end 124, securing the support 120 in position around the pipe 101. If adjustments are needed, such as repositioning to accommodate a pipeline component 106 or to achieve better alignment, the installer may disengage the first fastener 130, make the necessary adjustments, and then reengage the first fastener 130 to hold the corrected position. After confirming proper alignment and fit, the installer may apply the second fastener 132 to permanently couple the first end 123 and the second end 124, creating a weatherproof seal. Finally, the installer may place the second insulation shield 104b back onto the support 120, positioning it opposite the first insulation shield 104a to form a substantially continuous protective encasement around the insulating medium 122.

The pipe hanger support 120 may be used with a plurality of different types of pipe hangers 110. In certain aspects, the pipe hanger 110 may be a clevis hanger or a band hanger, depending on the specific requirements of the installation. Additionally, the pipe hanger 110 may include a U-bolt clamp in some implementations, providing an alternative method of securing the pipe 101. As illustrated in FIG. 1, a U-bolt clamp configuration may include a top portion 116 that comprises the threaded bolted elements of the U-bolt that extend above the pipe 101. These bolted elements of the top portion 116 may secure the U-bolt to the hanger body 112, creating a complete clamping mechanism around the pipe 101. The top portion 116 of the U-bolt clamp may exert pressure on the top end 103 of the pipe 101, which is why additional support inserts 126 may be positioned at the fourth location 129c to protect the insulating medium 122 at this contact point. Although only one support insert 126 is shown, more are possible (e.g., 3 or more). The U-bolt configuration of the shown system 100 may provide robust pipe support while the pipe hanger support 120 ensures that the integrity of the insulating medium is maintained at all contact points between the pipe 101 and the pipe hanger 110.

The system 100 may also include a pipeline component 106, which may represent various elements or accessories commonly found in piping systems. This component may interact with, and/or be enclosed or supported by the pipe hanger support 120, further demonstrating the versatility of the system 100. The insulating medium 122, or the pipe hanger support 120 more generally, may thus be compatible with additional pipeline components 106 such as heat trace cables, which may be accommodated between the pipe hanger support 120 and the pipe 101.

The pipeline component 106 may include various elements that are commonly integrated into or associated with piping systems. For example, the pipeline component 106 may be a heat trace cable or similar, a valve, a sensor (e.g., a temperature probe, pressure gauge, level indicator, corrosion monitoring device, and so forth), a flow meter or other measurement device, a pipe fitting, a safety device, and the like. In some instances, the pipeline component 106 may project from, or be accessible through, the pipe hanger support 120—e.g., the insulating medium 122 may be cut or penetrated by a pipeline component 106 (e.g., a drain, a relief valve, and the like).

The system 100 may provide for simplified installation of one or more pipeline components 106 due to the versatile design of the pipe hanger support 120. In some implementations, installers may initially secure the pipe hanger support 120 around the pipe 101 using the first fastener 130, allowing for temporary positioning and adjustment. This temporary fastening may then be disengaged, creating access for the installation or modification of pipeline components 106 between the pipe hanger support 120 and the pipe 101. After the pipeline components 106 are in place, the pipe hanger support 120 may be re-engaged using the first fastener 130, allowing for final adjustments to ensure proper alignment and fit. Once the optimal configuration is achieved, the second fastener 132 may be employed to create a more permanent and weatherproof seal, securing the pipe hanger support 120 and enclosing the pipeline components 106 in their final positions. This staged installation process may enhance flexibility during assembly while still providing a robust and long-lasting insulation solution.

The support 120 may include one or more channels 107 formed in an inner surface of the insulating medium 122. The one or more channels 107 may be sized and shaped to receive a pipeline component 106 therethrough, e.g., for accommodating runs of heat trace cables, sensor cables, heating elements, control elements, or the like. The support 120 may include a plurality of channels through the insulating medium 122 to accommodate multiple pipeline components 106 simultaneously. For example, two, three, or more channels (e.g., parallel channels) may be formed in the inner surface of the insulating medium 122, where these channels can allow for, e.g., multiple heat trace cables to be fed through the support without requiring drilling or cutting the insulation in the field. The channels 107 may allow pipeline components 106 such as heat trace cables to pass longitudinally through the support 120 while maintaining contact between the insulating medium 122 and the pipe surface in non-channeled regions. This configuration provides a ‘pass-through’ capability that protects the pipeline components 106 from being crushed against a pipe by the compressive force of a hanger, a support structure, or similar.

The channel 107 may be sized and shaped to receive the pipeline component 106. By way of example, and as referenced above, the channel 107 may be sized and shaped to receive a heat trace cable therethrough. In this manner, the pipe hanger support 120 may be installed on a pipe 101 (permanently or temporarily), and a heat trace cable or other pipeline component 106 may be installed within or through the channel 107 or the like. The channel 107 may be located along a bottom half of the pipe 101, which may be advantageous to maintain a desired temperature of contents that may settle along the bottom of the pipe 101, or where a pipe 101 is not completely filled with such contents at all times.

In some cases, a sealing compound may be applied to the insulating medium 122, or it may be used in conjunction with adjacent insulation portions made of materials such as rubber, fiberglass, polyisocyanurate, foam glass, calcium silicate, and the like. The sealing compound may serve to enhance or reinforce the weatherproofing properties of the pipe hanger support 120, creating a moisture-resistant barrier at the interfaces between different insulation components. This sealing may be particularly important at the junctions where the pipe hanger support 120 meets standard pipe insulation sections, helping to maintain thermal efficiency and prevent condensation issues. Additionally, a protective jacket or the like may be applied to the pipe hanger support 120 to provide further protection against environmental factors, mechanical damage, UV exposure, and the like. This protective jacket may be formed from materials such as plastic, PVC, aluminum, stainless steel, or other weatherproof coverings that complement the underlying insulation system while extending its service life and enhancing its appearance. The protective jacket may be designed to seamlessly integrate with jacketing on adjacent pipe insulation sections, creating a continuous protective envelope around the entire insulated pipe system. Such a protective jacket or the like may also or instead prevent damage such as ripping or tearing of the insulating medium 122 or other parts of the pipe hanger support 120. Also or instead, such a protective jacket may form a vapor barrier, and/or may provide an overall aesthetically pleasing look. An example of such a protective jacket can include a zero permeability vapor barrier cladding such as VentureClad™, a trademark and product of 3M Company, Delaware, United States. Such a protective jacket may be placed on one or more surfaces of the pipe hanger support 120, e.g., its entire top and bottom surface, and/or side surfaces thereof. However, it will be understood that the system 100 may lack such a protective jacket, which may not be needed in such a system 100 as described herein, which is a potential benefit of the present teachings relative to existing techniques.

In certain aspects, a protective jacket, heat shield, or similar placed on one or more surfaces of the pipe hanger support 120 may have insulating properties in addition to, or instead of, providing mechanical protection and weatherproofing. For example, the protective jacket or heat shield may be disposed on an interior surface of the insulating medium 122, that is, the surface facing the pipe 101, for protecting the insulating medium 122 from the pipe 101. This configuration may be particularly advantageous for high temperature piping systems, especially when the insulating medium 122 is formed from a rubber material or similar elastomeric compound that may have temperature limitations. By interposing an insulating protective jacket or heat shield between the pipe 101 and the insulating medium 122, the thermal exposure of the insulating medium 122 may be reduced, potentially extending its service life and maintaining its structural integrity in elevated temperature environments. This approach may thus enable use of aspects of the present teachings in hot piping systems, such as steam lines, hot water distribution systems, or industrial process piping, as well as, or instead of, cold piping systems such as chilled water applications. The insulating protective jacket or heat shield may be formed from materials capable of withstanding higher temperatures while providing a thermal buffer, such as high-temperature resistant polymer films, ceramic fiber blankets, mineral wool wraps, and the like.

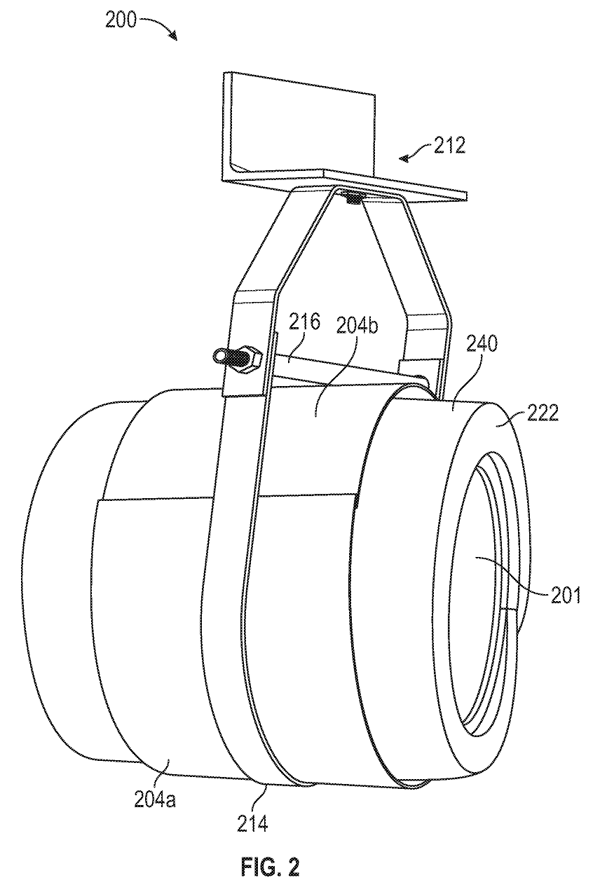

FIG. 2 shows a system 200 for protecting the integrity of insulation, according to a representative example. The system 200 may be the same or similar to that shown and described with reference to FIG. 1, where any of the components and features described above or elsewhere herein may be included in the system 200 of FIG. 2, and vice-versa. The system 200 includes a pipe 201 supported by a hanger assembly including a hanger body 212 and a load-bearing member 214, a plurality of insulation shields (e.g., a first insulation shield 204a and a second insulation shield 204b), an insulating medium 222 of a pipe hanger support, and/or a vapor barrier 240 as per the present teachings. In an aspect, the system may include a plurality of pipe hangers and pipe hanger supports spaced apart along the length of the pipe 201.

The first insulation shield 204a may be positioned between the load-bearing member 214 and the pipe 201, or more specifically between the load-bearing member 214 of the hanger and the insulating medium 222 of the pipe hanger support. The first insulation shield 204a may have a curved profile to match the contour of the pipe 201, helping to distribute the weight evenly and prevent localized stress on the insulation.

The second insulation shield 204b may be located near a top portion 216 of the hanger assembly. Stated otherwise, the second insulation shield 204b may be placed between the top end of the pipe 201 and the top portion 216 of the pipe hanger. This configuration may provide additional protection for the insulation at the upper contact point between the pipe 201 and the hanger assembly. In certain aspects, the first insulation shield 204a and the second insulation shield 204b are structurally configured to overlap or meet, thereby forming a complete 360-degree encasement around the insulating medium 222. The first insulation shield 204a and second insulation shield 204b may be formed from a heavy-gauge material, such as 16-gauge galvanized steel, to provide a robust layer of protection against high compressive loads, impact, and environmental debris. This 360-degree configuration may be particularly advantageous for preventing a pipe hanger from cutting into the vapor barrier or insulation under extreme loads or thermal expansion cycles.

The hanger body 212 may be configured in various ways to accommodate different pipe support scenarios. In some implementations, the hanger body 212 may be an overhead support structure, such as a beam, truss, or ceiling-mounted bracket, from which the load-bearing member 214 is suspended to support the pipe 201 from above. Alternatively, the hanger body 212 may be a ground-based support structure, such as a concrete pad, metal frame, or adjustable pedestal, designed to support the pipe 201 from below. In other aspects, the hanger body 212 may be a wall-mounted bracket or a vertical structural member capable of supporting the pipe 201 from the side. The versatile nature of the pipe support system 200 may thus accommodate different types of pipe hangers and can thus be adapted for various installation environments, including overhead installations, floor-mounted configurations, and wall-supported arrangements, while maintaining the protective benefits of the insulating medium 222 and insulation shields 204a and 204b.

The insulating medium 222 of the pipe hanger support may wrap around the pipe 201, providing insulation protection at the hanger location. Specifically, the insulating medium 222 is shown positioned between the pipe 201 and both the first insulation shield 204a and second insulation shield 204b, helping to maintain the structural integrity of the insulation at the support points. That is, the pipe hanger support may include embedded support inserts as described herein, where these inserts provide support for the insulation properties of the insulating medium, which provides the insulation at the hanger location. In this manner, the pipe hanger support may provide comprehensive protection at critical contact points. When wrapped around a pipe 201, the support inserts at a first location may align with the bottom end of the pipe 201 where it contacts the load-bearing member 214 of the hanger, while support inserts at a second location may align with the top end of the pipe 201 where it may contact a bolt or other top portion 216 of the pipe hanger. This (at least) dual-support configuration may ensure that the insulation properties of the insulating medium 222 are maintained at all points where compressive forces from the pipe hanger might otherwise compromise the insulation integrity. For example, the strategic placement of support inserts at both top and bottom positions may allow the pipe hanger support to provide complete circumferential protection while maintaining the flexibility needed for installation and storage.

The system 200 may include a vapor barrier 240 disposed on an exterior surface of the insulating medium 222 and/or on an interior surface of the insulating medium 222. The vapor barrier 240 may be any as described herein, including sheeting materials, foil materials, membranes, coatings, or the like.

In certain aspects, and as shown in FIG. 2, the load-bearing member 214 may include at least a portion of a clevis hanger, with the top portion 216 including a rod and/or bolt of the clevis hanger, or similar. This configuration may provide secure support for the pipe 201, where integration of the second insulation shield 204b may protect the insulation from compression at the point where the pipe support system 200 contacts the bolted portion, or other portion of the load-bearing member 214. As described herein, support inserts at the second location may be structurally configured to protect the insulating medium 222 from the top portion 216 of the pipe hanger, particularly in the case of a U-bolt clamp configuration (see also FIG. 1) or similar. To facilitate the alignment of the second insulation shield 204b (e.g., a top shield) before the pipe hanger is tightened, the shield may comprise a temporary adhesive element disposed on its inner concave surface. For example, the adhesive element may be a strip of double-sided tape. In this manner, during installation, a user may remove a release liner from the tape and press the shield onto the top surface of the insulating medium 222, which secures the shield in the “top center” position, preventing it from sliding or falling while the installer positions and tightens the U-bolt or clamp.

In certain aspects, the pipe 201 may have a diameter of 4-inches or greater (e.g., 12-inches (30.48 cm) or greater), demonstrating the system’s capability to accommodate larger pipe sizes commonly found in industrial and commercial applications. The pipe 201 may be a chilled water pipe, highlighting the importance of maintaining effective insulation to prevent condensation and energy loss in cooling systems.

The orthogonal view provided in FIG. 2 emphasizes the comprehensive nature of the insulation protection offered by the system 200, showcasing how the insulating medium 222 works in conjunction with the first insulation shield 204a and second insulation shield 204b to provide continuous insulation coverage around the entire circumference of the pipe 201 at the hanger location.

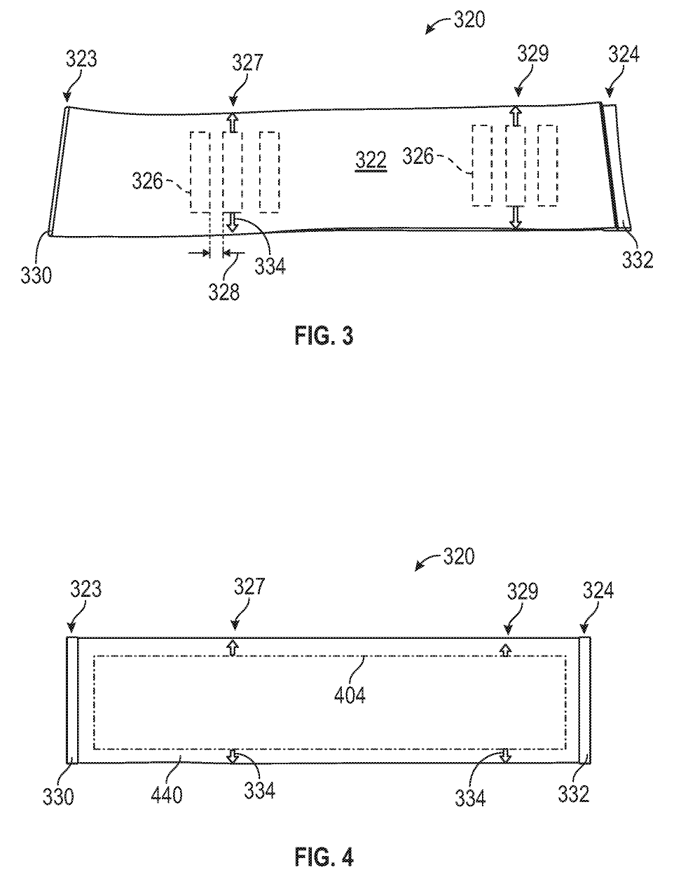

FIG. 3 shows a first side of a pipe hanger support 320 for safeguarding insulation, and FIG. 4 shows a second side of the pipe hanger support 320 (i.e., the opposite side of that shown in FIG. 3), according to a representative example. Each of these figures show the pipe hanger support 320 in a flat configuration, which may, in an aspect, be a configuration used for shipping and/or storage. Alternatively, and as described herein, the pipe hanger support 320 may be configured and shipped in a substantially cylindrical configuration that approximates its installed shape when wrapped about a pipe. This pre-formed cylindrical shipping configuration may include a breakaway seam that maintains the cylindrical structure during transport and storage while permitting easy separation of the first end 323 and the second end 324 for installation about a pipe at a hanger location.

The pipe hanger support 320 may include an insulating medium 322 (such as any described herein, e.g., rubber or the like) formed as a continuous body defining a length between a first end 323 and a second end 324. The pipe hanger support 320 may further include multiple support inserts 326 embedded within the insulating medium 322, a first fastener 330, a second fastener 332, and one or more markings 334. The insulating medium 322 is shown laid flat, demonstrating how, in certain aspects, the pipe hanger support 320 may be stored in a substantially flat configuration while maintaining embedded inserts at their designated locations. That is, the flat configuration of the pipe hanger support 320 shown in FIGS. 3 and 4 may allow for efficient storage and transportation in some example aspects of the present teachings. When installation is required, the flexibility of the insulating medium 322 may permit on-site shaping to conform to a specific pipe circumference, potentially simplifying the installation process and reducing the need for multiple pre-curved sizes to be kept in inventory.

The support inserts 326 may be any as described herein. For example, the support inserts 326 may include materials such as high-density molded fiberglass, phenolic foam, polymers, wood, or the like. In some implementations, the support inserts 326 may include calcium silicate. In general, a flexibility of the insulating medium 322 and a predetermined spacing between the support inserts 326 may permit: (i) the insulating medium 322 with the support inserts 326 embedded therein to be wrapped about an external circumference of a pipe, and (ii) the insulating medium 322 with the support inserts 326 embedded therein to be stored substantially flat.

The support inserts 326 may be disposed at one or more of a first location 327 and a second location 329 along the length of the body of the insulating medium 322. The first location 327 may be a predetermined location along the length of the insulating medium 322 such that, when the insulating medium 322 is wrapped about a certain diameter pipe, the pipe hanger support 320 envelops the pipe such that the support insert 326 that is present at the first location 327 is disposed adjacent to a bottom end of the pipe for positioning between the bottom end of the pipe and a support such as a pipe hanger. Thus, the first location 327 may be determined relative to (1) the length of the insulating medium 322 and/or pipe hanger support 320, and (2) the diameter of the pipe intended for use with the pipe hanger support 320.

Also or instead, one or more of the support inserts 326 may be embedded within the continuous body of the insulating medium 322 at a second location 329 along the length. The second location 329 may be selected such that the pipe hanger support 320, when wrapped about a pipe having a certain diameter, envelops the pipe with a support insert 326 disposed adjacent to the top end of the pipe, e.g., for protecting the insulating medium 322 from a top portion of a pipe hanger or other support structure. Thus, the second location 329 may be determined relative to (1) the length of the insulating medium 322 and/or pipe hanger support 320, and (2) the diameter of the pipe intended for use with the pipe hanger support 320. Also or instead, the first location 327 and the second location 329 may be spaced apart in a manner such that the first location 327 is disposed opposite the second location 329 when the pipe hanger support 320 is wrapped about a pipe or other item or component intended for insulating. In this manner, each of a top end and a bottom end, or more generally a first side and as second side, of a pipe may be protected via the support inserts 326 present in the insulating medium 322 at these specific locations. In certain aspects, the pipe hanger support 320 may include at least four support inserts 326, where each is strategically placed along the insulating medium 322 and/or the pipe hanger support 320 at specific locations such that at least one support insert 326 is disposed substantially at each of a 12 o’clock position, a 3 o’clock position, a 6 o’clock position, and a 9 o’clock position along the circumference of a pipe having a predetermined diameter or other known dimension. In addition to, or instead of, the first location 327 and/or the second location 329, support inserts 326 may be positioned at intermediate locations along the length of the insulating medium 322 to provide lateral reinforcement at the sides of the pipe. These additional support insert locations may correspond to areas where side-mounted brackets, guide supports, or other lateral restraint mechanisms contact the pipe hanger support 320, ensuring comprehensive protection against compressive forces from multiple directions.

The support inserts 326—i.e., in one or both of the first and second locations, or in other locations along the body of the insulating medium 322—may be arranged with a predetermined spacing 328 between them. The predetermined spacing 328 may be selected such that the support inserts 326 provide adequate support while maintaining flexibility of the insulating medium 322. By way of example, the support inserts 326 may include at least two inserts spaced at least 1-inch apart, though this spacing may be adjusted based on factors such as pipe diameter, expected load, insulation thickness, support insert properties, insulation properties, hanger properties, and the like. The spacing configuration may create strategic zones of reinforcement while preserving flexible sections between the support inserts 326, allowing the pipe hanger support 320 to conform to a pipe’s curvature during installation while still providing robust protection at critical load-bearing points. This balanced approach to insert placement ensures that the pipe hanger support 320 may maintain its dual functionality—providing sufficient structural support to prevent insulation compression at contact points with the pipe hanger while retaining enough flexibility to be wrapped around pipes of various diameters and optionally stored flat when not in use. Additionally, the predetermined spacing 328 may be optimized to distribute compressive forces substantially evenly across the insulating medium 322, potentially extending the service life of both the pipe hanger support 320 and the underlying insulation by preventing localized stress concentrations.

The pipe hanger support 320 may further include a first fastener 330 disposed on one or more of the first end 323 and the second end 324 of the continuous body of the insulating medium 322. The first fastener 330 may be any as described herein, e.g., a hook and loop fastener or similar. The first fastener 330 may be structurally configured to selectively and releasably couple the first end 323 and the second end 324 of the insulating medium 322. The pipe hanger support 320 may also or instead include a second fastener 332 configured to form a permanent bond between the first end 323 and the second end 324 of the insulating medium 322. The second fastener 332 may be any as described herein, e.g., a self-sealing lap tape or similar. While hook and loop fasteners and adhesive tape are depicted in the exemplary embodiments, the fastening mechanisms are not limited to these specific types; other types of fasteners may also or instead be used, including hook and loop components, snap fasteners, magnetic fasteners, interlocking plastic tabs or clips, elastic straps or bands, and the like, as described elsewhere herein.

The pipe hanger support 320 may include one or more markings 334 positioned along the length of the insulating medium 322. The markings 334 on the pipe hanger support 320 may indicate alignment guides for placement and/or locations of the support inserts 326. These markings 334 may assist in proper installation and positioning of the pipe hanger support 320 around a pipe. Although an arrow is shown in these figures, it will be understood that the markings 334 may include a variety of different things, and can have a variety of different meanings, thus serving one or more purposes for the pipe hanger support 320 and systems that use the same. For example, the markings 334 may include directional indicators such as arrows or text (e.g., “TOP” and “BOTTOM”) to ensure proper orientation during installation. The markings 334 may also or instead include measurement indicators, color-coded sections to differentiate areas with support inserts 326 from those without, product specifications such as temperature ratings, pipe diameter compatibility information, and the like. Additionally or alternatively, the markings 334 may include installation instructions, manufacturer information, reference points for cutting when customization is required for specific pipe sizes, and the like. The markings 334 may be printed, embossed, or otherwise permanently or temporarily applied to a surface of the insulating medium 322 (either or any surface) during manufacturing to ensure that they remain visible throughout the product’s service life.

During installation, the markings 334 may serve multiple practical functions beyond mere identification of support insert locations. Installers may use the markings 334 to properly center the pipe hanger support 320 relative to the pipe hanger, ensuring optimal load distribution and preventing misalignment that could compromise insulation integrity. The markings 334 may also or instead facilitate proper alignment with adjacent insulation sections, helping to create seamless transitions that maintain continuous thermal protection. In maintenance scenarios, the markings 334 may assist technicians in quickly identifying the type and specifications of the installed pipe hanger support 320, potentially expediting repair or replacement procedures. This marking system may enhance the usability of the pipe hanger support 320 by reducing installation errors, ensuring optimal positioning for maximum insulation protection, and providing essential reference information throughout the product’s lifecycle.

In certain aspects, one or more of a top surface and a bottom surface of the insulating medium 322 may include a vapor barrier 440 that is not compromised by the inclusion of the embedded support inserts 326. This vapor barrier 440 may ensure consistent protection against moisture infiltration along the entire length of an insulated pipe. In some aspects, the material of the insulating medium 322 itself, or a jacket permanently applied thereto, may comprise the vapor barrier 440. In an aspect, the pipe hanger support 320 may include a vapor barrier 440 disposed along an entire surface—or a majority thereof—of the insulating medium. The vapor barrier 440 may include an insulation jacket or sheet, which may be designed to protect and enhance the performance of thermal insulation in various commercial and industrial applications. Also or instead, one or more components may be used to seal portions of the insulating medium 322 to form a vapor barrier—e.g., such as one or more pieces of material (e.g., the same material as the insulating medium 322) that may be applied along one or more portions of the insulating medium 322 (such as where the support inserts 326 are located) to reinforce these regions and/or provide the vapor barrier 440. Alternative vapor barrier implementations may include thin aluminum foil laminated to the surface of the insulating medium 322, metalized polymer films adhered to the insulating medium 322, specialized vapor barrier paints or coatings based on epoxy resins and/or polyurethane that create a moisture-impermeable layer, spray-on (e.g., elastomeric) coatings that form a substantially continuous, seamless barrier when cured, multi-layer composite materials (e.g., where polyethylene or polypropylene film is sandwiched between layers of insulating material during manufacturing), water-repellent treatments such as silicone-based or fluoropolymer impregnations that create a hydrophobic surface, membranes (e.g., butyl rubber) that provide moisture resistance and can be heat-sealed at joints for complete protection, and the like. In certain aspects, the vapor barrier 440 includes VentureClad™ from 3M or similar. In an aspect, the vapor barrier 440 may include one or more of: a sheeting of material (e.g., polyethylene sheeting), a foil material, a membrane, a rigid foam, a foil-backed board or other material, a paint, a sealant, a tape, and the like. A sealing compound may also or instead be applied to the pipe hanger support 320. In some implementations, the sealing compound may be present on tape applied to the pipe hanger support 320—e.g., between adjacent insulation portions along a pipe, and/or at discrete locations along the insulating medium 322. In general, any type of vapor barrier may be included in the present teachings such as one or more of mastics, sealants, tapes, cladding, and the like.

The vapor barrier 440 may serve one or more of a variety of purposes including structural protection (e.g., from crushing, chipping, scraping, etc.), maintaining an insulating property, creating or maintaining a seal to prevent moisture penetration or other penetration of a contaminant, reinforcing weaker areas along the insulating medium 322, aesthetic purposes, and so forth. Characteristics of the vapor barrier 440 may include: being a zero permeability vapor barrier—engineered to provide an absolute vapor barrier, preventing moisture from migrating into the insulation, which can be helpful for preventing corrosion under insulation (CUI), mold growth, and maintaining the thermal efficiency of the insulation; multi-layered laminate construction—e.g., composed of multiple layers, often including aluminum or other durable materials, which can contribute to strength and performance; use of aggressive cold weather acrylic adhesive, helpful to promote a long-lasting bond and resistance to lifting or curling; high puncture and tear resistance; easy installation; weather and chemical resistance—e.g., resistance to weathering, UV exposure, ozone, high humidity, salt spray, oil, grease, and aggressive chemicals, ensuring long-term performance in challenging environments; having different aesthetic options—e.g., various colors such as silver and white, and finishes such as flat or embossed; compliance and certifications; and so forth.

The vapor barrier 440 may be applied through several different methods and configurations depending on the specific requirements and manufacturing processes. In some implementations, the vapor barrier 440 may be applied as a continuous coating across the entire surface—potentially the entire outer structure—of the insulating medium 322 and/or pipe hanger support 320. This may involve spray application techniques where specialized vapor barrier compounds are uniformly distributed over the insulating material using automated spray systems or manual application methods. The coating process may be performed in controlled environments to ensure proper adhesion and curing of the vapor barrier material. In other aspects, the vapor barrier 440 may be applied through lamination processes where pre-formed barrier films or sheets are bonded to the insulating medium 322 under heat and pressure. This lamination approach may utilize adhesive systems specifically designed for vapor barrier applications, ensuring a strong and durable bond between the barrier material and the insulating substrate. The lamination process may be performed using roll-to-roll manufacturing equipment for continuous production or batch processing methods for smaller quantities. The vapor barrier may also or instead be applied through dip-coating processes where the insulating medium 322 is immersed in a liquid vapor barrier solution and then withdrawn at controlled speeds to achieve uniform coating thickness. This method may be particularly suitable for complex geometries or when complete surface coverage is required. Following the dip-coating process, the coated material may undergo curing or drying processes to activate the vapor barrier properties. In certain implementations, the vapor barrier 440 may be applied using brush or roller application methods, particularly for field applications or repair situations. These manual application techniques may allow for precise control over coating thickness and coverage in specific areas where vapor barrier reinforcement is needed. The application may be performed in multiple thin coats to build up the desired barrier thickness while avoiding runs or sags in the coating. The vapor barrier 440 may also be applied through extrusion coating processes where molten barrier materials are directly applied to the insulating medium 322 as it passes through manufacturing equipment. This approach may create a strong mechanical bond between the barrier and substrate materials while maintaining consistent thickness and coverage. The extrusion process may be particularly suitable for high-volume production applications. In some cases, the vapor barrier 440 may be applied as discrete patches or strips in areas where enhanced protection is needed, such as around embedded support inserts 326 or at joint locations. These targeted applications may use pressure-sensitive adhesive tapes or heat-activated films that conform to the contours of the insulating medium 322 while providing effective moisture protection.

As further shown in FIG. 4, the pipe hanger support 320 may include an insulation shield 404. That is, in certain aspects, the insulation shield 404 may be integrated directly into the pipe hanger support 320, eliminating the need for a separate component. In some implementations, a thin, low gauge steel sheet or plate may be adhered or otherwise secured to one or more surfaces of the insulating medium. For example, the steel sheet may be bonded to the outer surface of the insulating medium, providing a durable, load-bearing surface that interfaces with the pipe hanger or other support structure. Alternatively, the steel sheet may be incorporated into the inner surface of the insulating medium, offering direct protection to the pipe. The material and thickness of the integrated insulation shield 404 may be carefully selected to maintain the flexibility of the pipe hanger support 320. This design consideration may allow the pipe hanger support 320 to be shipped in a flat configuration and remain pliable enough to be wrapped around pipes of various diameters during installation, even with the inclusion of the insulation shield 404. In some aspects, the insulation shield 404 may be segmented or feature strategically placed relief cuts to enhance flexibility while retaining its protective properties. For example, relief cuts may be present on the interior of the insulating medium to promote better wrapping about a pipe.

In certain implementations, the integrated insulation shield 404 may be embedded within the insulating medium during a manufacturing process. This approach may involve placing a steel sheet or plate between layers of the insulating material, creating a sandwich-like structure that combines the benefits of both components. The embedded design may help preserve the overall flexibility of the pipe hanger support 320 while providing enhanced load distribution and protection against compression.

The insulation shield 404 may include one or more of a variety of sizes, shapes, and materials. For example, the insulation shield 404 may be constructed from a variety of materials, including low gauge steel, stainless steel, aluminum, or high-strength polymers. In some implementations, composite materials combining metal and polymer layers may be used to optimize strength, weight, and flexibility. The choice of material may depend on factors such as the expected load, environmental conditions, and compatibility with the insulating medium and pipe materials.

The integration of the insulation shield 404 into the pipe hanger support 320 may offer several advantages, including simplified installation, reduced risk of component misalignment, and potentially improved thermal performance by eliminating air gaps between separate components. Additionally, this unified design may enhance the overall durability and longevity of a pipe hanger support system. However, it will be understood that the insulation shield 404 may still be used with, and/or cooperate with, an external shield—e.g., where a project engineer would like an additional pipe support (saddle) that is a higher gauge metal or similar.

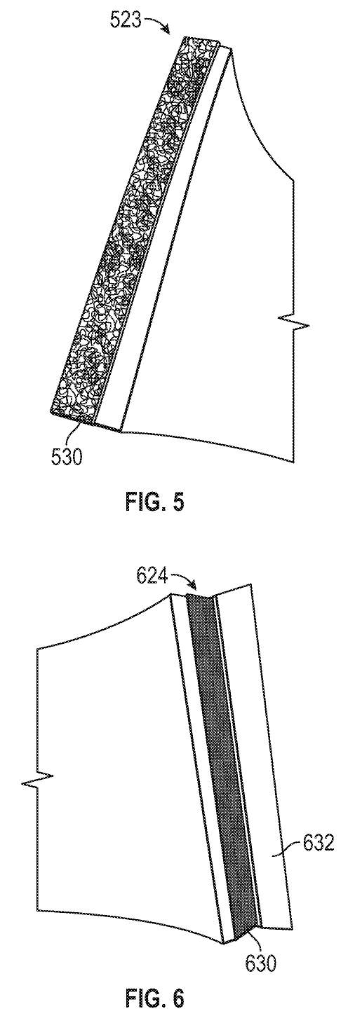

FIG. 5 shows a first end 523 of a pipe hanger support for safeguarding insulation, and FIG. 6 shows a second end 624 of the pipe hanger support for safeguarding insulation, according to a representative example. That is, FIG. 5 shows a first end 523 of the pipe hanger support, which includes a first fastener 530; and FIG. 6 shows a second end 624 of the pipe hanger support, which includes both a first fastener 630 and a second fastener 632. Other configurations are also or instead possible—including, for example, where one or more fasteners are not located on these ends, where the first end 523 also includes the second fastener 632, or where only one end includes one or more fasteners. It will be understood that the fasteners shown may be supplemented with or replaced by any one or more of the fasteners described elsewhere herein.

In certain aspects, a fastener (one or more of the first or second fasteners) may include multiple components. For example, the first fastener 530, 630 may include a component on each end of an insulating medium forming a body of a pipe hanger support as described herein. That is, the first fastener 530, 630 may be placed on one or more of the first end 523 and the second end 624 of the insulating medium. In certain aspects, the first fastener 530, 630 may include a hook and loop component (e.g., where the first fastener 530 of FIG. 5 includes the loop component, and where the first fastener 630 of FIG. 6 includes the cooperating hook component), which allows for selective and releasable coupling of the first end 523 and the second end 624 of the insulating medium. This configuration may facilitate easy installation and adjustment of the pipe hanger support around a pipe. Also or instead, the first fastener 530, 630 may include one or more cooperating components on opposing ends of the body of the pipe hanger support.

The first fastener 530, 630 may lack an adhesive as the coupling means for opposing ends of the pipe hanger support. The absence of adhesive in the first fastener 530, 630 may allow for repeated attachment and detachment without degradation of the fastening mechanism. This feature may be particularly useful during initial positioning of the pipe hanger support or when access to underlying components is required for maintenance or inspection.

The second fastener 632 may be placed on one or more of the first end 523 and the second end 624 of the insulating medium. In certain aspects, the second fastener 632 may include a tape component. The tape component may be designed to form a permanent bond between the first end 523 and the second end 624 of the insulating medium once the pipe hanger support is properly positioned around a pipe. The tape component of the second fastener 632 may include a self-sealing tape. Self-sealing tape may provide a strong, weatherproof seal that activates upon application, ensuring a secure and long-lasting bond between the ends of the insulating medium. The second fastener 632 may also or instead include an adhesive. The adhesive may be designed to create a permanent bond, effectively sealing the pipe hanger support around a pipe once installation is complete. This permanent seal may help maintain the integrity of the insulation system over extended periods, potentially reducing maintenance requirements and improving overall energy efficiency. In some aspects, the second fastener 632 may overlay (e.g., be positioned adjacent and exterior to) the first fastener 530, 630.

The combination of the first fastener 530, 630 and the second fastener 632 may provide a dual fastening system that enhances the versatility and performance of the pipe hanger support. The releasable nature of the first fastener 530, 630 may allow for initial positioning and adjustments, while the permanent bonding capability of the second fastener 632 may ensure long-term stability and weatherproofing of the installed pipe hanger support.

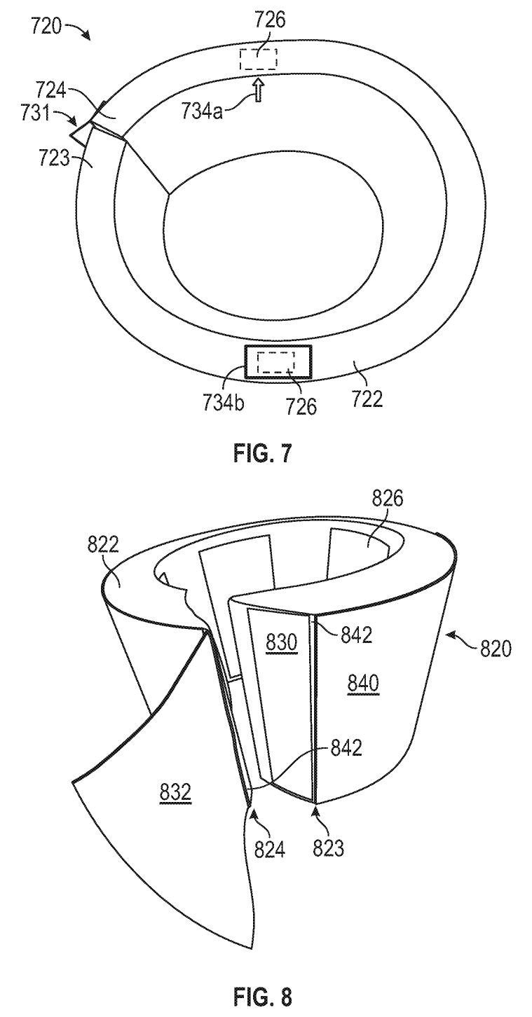

FIG. 7 shows a pipe hanger support for safeguarding insulation, according to a representative example. The pipe hanger support 720 may include any of the features of the other examples provided herein, and vice-versa. The pipe hanger support 720 may include an insulating medium 722 formed as a continuous body extending between a first end 723 and a second end 724. One or more support inserts 726 may be embedded within the insulating medium 722 at predetermined spaced intervals along the length of the body. A fastener 731 may be disposed on the insulating medium 722 for coupling the first end 723 and second end 724 when the support is wrapped around a pipe. The pipe hanger support 720 may include markings 734a, 734b that can serve as alignment guides during installation.

The insulating medium 722 with embedded support inserts 726 may maintain flexibility to allow the pipe hanger support 720 to be stored flat while also enabling it to be wrapped around a pipe during use. The pipe hanger support 720 may be disposed in a flat configuration when not in use, which may offer advantages for storage and transportation. When installation is required, the flexibility of the insulating medium 722 may allow for on-site shaping to conform to the specific pipe circumference, potentially simplifying the installation process and reducing the need for multiple pre-curved sizes to be kept in inventory. The support inserts 726 may be fully embedded within the insulating medium 722, e.g., to maintain the integrity of the vapor barrier properties of the insulating medium 722.

In certain aspects, the markings on the insulating medium 722 may include an alignment guide (e.g., marking 734a) for proper positioning of the pipe hanger support 720 during installation. For example, the markings 734 may include a “Bottom Center” decal or similar. During the installation process, the marking may be aligned with the bottom center of the pipe to ensure correct placement of the pipe hanger support 720. In another example, a marking 734b may be included, e.g., at the first location 327, to indicate that this region of the support should be located at a certain location along a pipe or other structure—e.g., the first location 327 should be disposed beneath the pipe at its substantial bottom thereof.

The arrangement of the support inserts 726 along the length of the insulating medium 722 may be designed to provide optimal support when the pipe hanger support 720 is wrapped around a pipe. The spacing between the support inserts 726 may allow for flexibility of the insulating medium 722 while still providing adequate structural support at key points.

The fastener 731 may be positioned near one or both ends of the insulating medium 722 to facilitate secure attachment when the pipe hanger support 720 is installed around a pipe. In some implementations, the fastener 731 may be a temporary fastening mechanism to allow for adjustments during installation before a more permanent seal is applied.

FIG. 8 shows a pipe hanger support for safeguarding insulation, according to a representative example. The pipe hanger support 820 may be the same or similar to other pipe hanger supports described herein, and may thus include any one or more features of such supports and support systems as described herein, and vice-versa. In general, the pipe hanger support 820 may include an insulating medium 822 and one or more support inserts 826 embedded therein at one or more locations about the circumference of the shape formed by the insulating medium 822. The pipe hanger support 820 may also include a first end 823 and a second end 824 that are couplable—e.g., using at least a first fastener 830 and a second fastener 832. A vapor barrier 840 may also be included on an exterior of the pipe hanger support 820. In certain aspects, the vapor barrier 840, or another component of the pipe hanger support 820, may include a breakaway seam 842 or similar, as described herein.

The first fastener 830 may include an adhesive component, such as a double-sided tape or similar adhesive strip, formed directly on a slit or edge portion of the insulating medium 822. In such implementations, the adhesive may be pre-applied during manufacturing and protected by a release liner until installation, allowing the installer to simply peel away the liner and press the first end 823 against the second end 824 to create a secure bond. This configuration may provide a substantially airtight and robust seal without requiring extra tooling, brushes, or field-applied adhesives, potentially simplifying the installation process and reducing the risk of improper sealing. The adhesive-based first fastener 830 may offer advantages in terms of seal integrity compared to mechanical fastening approaches, as the continuous adhesive contact may help prevent air infiltration and moisture ingress along the seam. Other types of fasteners may also or instead be used for the first fastener 830, including hook and loop components, snap fasteners, magnetic fasteners, interlocking plastic tabs or clips, elastic straps or bands, and the like, as described elsewhere herein.

The second fastener 832 may include a self-sealing lap tape or similar component configured to overlay and reinforce the closure formed by the first fastener 830. In some implementations, the self-sealing lap tape may be positioned adjacent to or overlapping the first fastener 830, providing an additional layer of sealing that enhances the weatherproofing and structural integrity of the closure. The self-sealing lap tape may be designed to bond to itself or to the vapor barrier 840 material when pressed together, creating a permanent seal that resists peeling or separation over time. When used in conjunction with the adhesive-based first fastener 830, the second fastener 832 may provide redundant sealing that addresses both the inner and outer surfaces of the closure region, helping to maintain vapor barrier continuity and prevent moisture infiltration at the seam. This dual-fastener approach may allow the first fastener 830 to establish initial positioning and primary sealing while the second fastener 832 provides long-term durability and enhanced environmental protection.

The breakaway seam 842 may include a breakable connection between the first end 823 and the second end 824 of the pipe hanger support 820. In some aspects, the breakaway seam 842 may be formed as a perforated line, a scored region, or a weakened material section that maintains structural continuity during shipping and storage while permitting easy separation when installation is desired. This configuration may allow the pipe hanger support 820 to be shipped and stored in a pre-formed, substantially cylindrical structure where the breakaway seam 842 remains intact, connecting the first end 823 and the second end 824 in a closed loop configuration. The cylindrical shipping form may provide benefits such as protecting the interior surface of the insulating medium 822 from contamination, maintaining the curved shape of the support for easier installation (while making installation more intuitive to installers), and reducing packaging requirements compared to flat storage configurations.

The breakaway seam 842 may also or instead include a peelable seam formed by a releasable adhesive bond or a frangible material layer that allows the first end 823 and the second end 824 to be separated by peeling apart the joined surfaces. Other similar structures may include kiss-cut sections, die-cut tabs, or weakened adhesive zones that facilitate controlled separation while maintaining the integrity of the surrounding vapor barrier 840 and insulating medium 822 during the separation process.

The breakaway seam 842 may be positioned at a predetermined location along the circumference of the pipe hanger support 820, such as along a longitudinal seam where the first end 823 and the second end 824 meet when the support is in its cylindrical shipping configuration. In some implementations, the breakaway seam 842 may be located at a position that corresponds to a non-critical region of the installed support, such as along a region of the support that is disposed away from where support inserts 826 are typically positioned. This placement may allow the installer to separate the ends without disturbing the structural reinforcement provided by the embedded support inserts 826.

The pipe hanger support 820 may include one or more markings that indicate the location of the breakaway seam 842 and provide guidance for proper separation. In some aspects, printed text such as “TEAR HERE,” “CUT ALONG LINE,” or similar instructions may be applied to the vapor barrier 840 or outer surface of the pipe hanger support 820 adjacent to the breakaway seam 842. The markings may also or instead include graphical indicators such as dashed lines, arrows, scissor icons, and/or contrasting color bands that visually distinguish the tearaway region from the remainder of the support surface. These markings may be printed, embossed, or otherwise applied during manufacturing to ensure visibility and durability throughout shipping and storage.

In certain implementations, the breakaway seam 842 may be designed for cutting by an installer using a utility knife, scissors, or similar cutting tool rather than tearing by hand. In such cases, the markings may include a continuous line or series of alignment marks that guide the cutting path to ensure a clean, straight separation. The marking system may include measurement indicators or reference points that help the installer verify proper alignment before cutting. Also or instead, the breakaway seam 842 may include a pull tab, grip strip, or raised edge feature that facilitates hand tearing without requiring cutting tools, where corresponding markings may indicate the direction of tear and the location of the pull tab.

When ready to install the pipe hanger support 820, an installer may break or tear the breakaway seam 842 to separate the first end 823 from the second end 824, thereby opening the cylindrical structure. The pipe hanger support 820 may then be wrapped about a pipe at a hanger location, with the first end 823 and the second end 824 subsequently coupled using the first fastener 830 and the second fastener 832 as described herein. The breakaway seam 842 may be positioned along the vapor barrier 840 or along another outer layer of the pipe hanger support 820, and may be designed to separate cleanly without leaving rough edges or compromising the integrity of the underlying insulating medium 822. The tearaway feature may also or instead be incorporated into the first fastener 830 or the second fastener 832, where a protective backing or release liner serves a dual function of maintaining the cylindrical form during shipping while also protecting an adhesive surface until installation.

The first end 823 and/or the second end 824 of the insulating medium 822 may be sized and shaped to cooperate with one another to enhance the coupling and sealing performance when the pipe hanger support 820 is wrapped around a pipe, or is otherwise installed for use. In some implementations, one or more of the ends may include angled cuts or beveled edges that create complementary mating surfaces. For example, one end may feature an angled cut that slopes inward while the corresponding end features an angled cut that slopes outward, allowing the ends to overlap and interlock when the insulating medium 822 is wrapped around the curved surface of a pipe. This angled configuration may provide improved contact area and reduce stress concentrations at the joint, potentially enhancing the effectiveness of either or both temporary and permanent fasteners. Other mating shapes may also or instead be employed, such as stepped or tiered end profiles where one end includes a raised portion that fits into a corresponding recessed portion on the opposite end. In certain aspects, the ends may feature curved profiles that match the curvature of the intended pipe diameter, allowing for more natural conformance when wrapped around cylindrical structures. Additionally, the ends may include tapered sections that gradually reduce in thickness toward the edge, creating a smoother transition and reducing bulk at any potential overlap joint. Some implementations may incorporate interlocking geometric features such as tongue-and-groove configurations, where one end includes a protruding tongue that fits into a corresponding groove on the opposite end, providing mechanical alignment and enhanced sealing capability when used in conjunction with the fastening systems described herein.

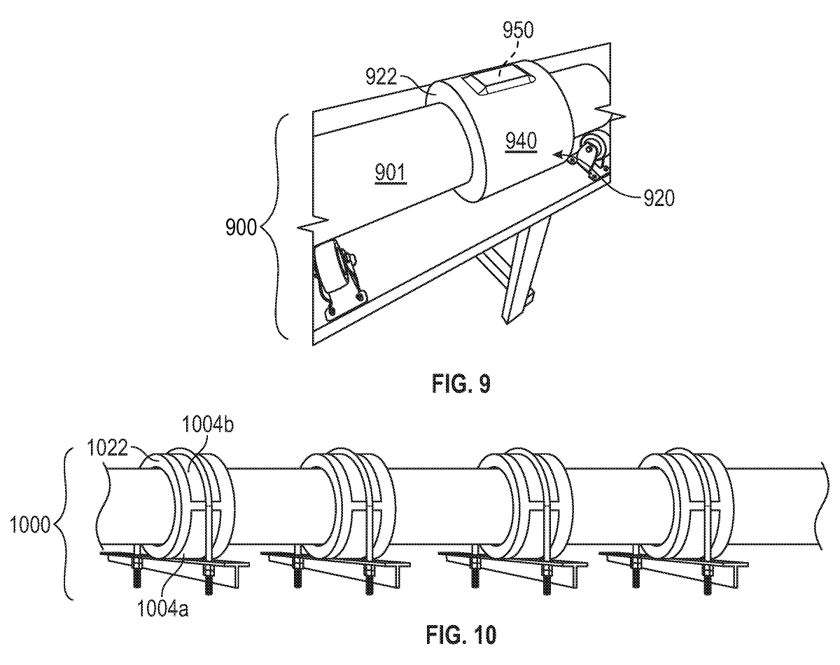

FIG. 9 shows a system for protecting the integrity of insulation, according to a representative example. The system 900 may generally include a pipe hanger support 920 and a pipe 901. The system 900—e.g., the pipe hanger support 920—may include one or more of the features described elsewhere herein, including with respect to other described systems and supports, and vice-versa.

The pipe hanger support 920 may include an insulating medium 922 having one or more embedded support inserts (not shown in this figure), where these components may be any as described herein. The pipe hanger support 920 may further include a load distribution member 950. That is, one or more load distribution members 950 may be incorporated into a pipe hanger support 920 device and/or system to address concentrated loading issues that can occur at certain pipe hanger locations. For example, the load distribution from clamping mechanisms such as U-bolts or similar fasteners onto a pipe for securing to a hanger can create concentrated forces at the (typically top) portion or along the bar portion of a hanger assembly. These concentrated loads may cause structural issues for insulation and/or an insulation protection system, including potential cracking or other compromising of embedded support inserts in the affected area, even when such supports are present within an insulating material such as the insulating medium 922. This problem may be particularly acute with rigid support insert materials such as calcium silicate, which may be susceptible to fracturing under concentrated point loads despite their high compressive strength properties.

To mitigate these loading concerns, a load distribution member 950—such as a steel plate or the like—may be integrated into the pipe hanger support 920. This load distribution member 950 may be specifically positioned to help distribute concentrated loads from a hanger across a wider area, reducing stress concentrations that could otherwise compromise embedded support inserts and/or the insulating medium 922 itself. The load distribution member 950 may thus function as an intermediate load-bearing component that receives concentrated forces from pipe hanger hardware and redistributes these forces over a larger contact area with the underlying support inserts and insulating medium 922.

The load distribution member 950 may be disposed external to the insulating medium 922 while remaining integral with the overall device assembly. In some aspects, the load distribution member 950 may be positioned on the outer surface of the insulating medium 922, to be disposed, when in use, beneath the anticipated contact area with the pipe hanger hardware. Alternatively, the load distribution member 950 may be positioned within the insulating medium 922, e.g., in a similar manner to the support inserts described herein.

In some implementations, the load distribution member 950 may be positioned beneath an outer protective layer 940 of the pipe hanger support 920, such as beneath a vapor barrier or another moisture-impermeable layer or similar sheeting. This configuration may allow the load distribution member 950 to be maintained in a fixed, predetermined location that will automatically align with an area of need when the pipe hanger support 920 is installed around a pipe at a hanger location. The integration of the load distribution member 950 beneath the outer protective layer 940 may ensure that it remains properly positioned and protected while providing the necessary load distribution function without requiring separate installation or alignment procedures during field installation.

The load distribution member 950 may be sized and shaped to correspond with an expected load pattern from specific types of pipe hangers, such as U-bolt assemblies, clevis hangers, band hangers, and so forth. For example, when used with U-bolt configurations, the load distribution member may have an elongated rectangular shape that spans a predetermined portion of the width of the U-bolt contact area to distribute loads to adjacent areas of the insulating medium 922.

The load distribution member 950 may be constructed from various materials, e.g., selected for their strength, durability, compatibility with the insulating medium 922, and so forth. In some aspects, steel plates may provide desired load distribution characteristics while maintaining relatively low weight and cost. The thickness of the load distribution member 950 (e.g., a steel plate) may be selected to provide adequate load distribution without significantly increasing the overall thickness or reducing the flexibility of the pipe hanger support 920. The load distribution member 950 may also or instead include aluminum plates, high-strength polymer sheets, or composite materials that combine metallic and non-metallic components to optimize strength-to-weight ratios.

The positioning and attachment of the load distribution member 950 may be carefully engineered to ensure proper alignment in combination with the embedded support inserts within the insulating medium 922. In some implementations, the load distribution member 950 may be positioned directly over one or more support inserts, creating a load path from the pipe hanger hardware through the load distribution member 950 and into the rigid support inserts. This configuration may help prevent localized crushing of the insulating medium 922 while ensuring that loads are effectively transferred to the most structurally capable components of the system. The load distribution member 950 may be secured to the pipe hanger support 920 (e.g., to the insulating medium 922) through various attachment methods, including adhesive bonding, mechanical fasteners, or integration during the manufacturing process of the pipe hanger support 920. By way of example, the load distribution member 950 may be placed on top of the insulating medium 922 at a predetermined location that will align with a certain portion of a pipe support to distribute a load therefrom when in use, and then fixed in that location via one or more of an adhesive and placement of an outer protective layer 940. The position and existence of the load distribution member 950 may be conspicuous, and/or the pipe hanger support 920 may include markings indicating the existence and/or location of the load distribution member 950.

FIG. 10 shows a system for protecting the integrity of insulation, according to a representative example. Specifically, FIG. 10 shows a pipe hanger support system 1000 featuring a one or more insulation shields that substantially envelop (e.g., fully envelop) a pipe hanger support. That is, the system 1000 may include a 360-degree protective metal encasement, in certain aspects. In FIG. 10, the system 1000 includes a first insulation shield 1004a (e.g., a bottom saddle) and a second insulation shield 1004b (e.g., a top shield) that cooperate to substantially fully encase the circumference of the support and the underlying insulating medium 1022.

The first insulation shield 1004a and the second insulation shield 1004b may be the same or may be different. In some aspects, one or more of the first insulation shield 1004a and the second insulation shield 1004b may be formed from a heavy-gauge material, such as 16-gauge galvanized steel, to provide a robust layer of protection against high compressive loads, impact, and environmental debris. The shields may overlap at an overlap region to ensure there are no gaps in the metal coverage; or there may be a small gap between the shields. In certain applications, a 360-degree configuration is particularly advantageous for preventing a U-bolt or hanger strap from cutting into the vapor barrier or insulation foam under extreme loads or thermal expansion cycles.

In an aspect, a plurality of pipe hanger supports may be arranged in parallel on a single structural strut member, such as a horizontal steel channel or I-beam. In this example support system, the pipe hanger supports effectively isolate the parallel pipes from the hard surface of the strut member, maintaining thermal integrity and preventing galvanic corrosion. In an aspect, the supports may be capable of bearing the weight of large-bore pipes (e.g., 24 inches or more) in a high-density configuration. This example demonstrates the adaptability of the support for ‘bottom-up’ support scenarios commonly found in industrial mechanical rooms and racking systems.

In addition, or instead, a rack support system may be arranged in a vertical configuration. In such a configuration, a plurality of pipes may be arranged vertically, one above the other, and supported by one or more common vertical suspension elements (e.g., a continuous threaded rod system). A pipe hanger support may be installed, e.g., at each respective tier of the stack. This tiered arrangement demonstrates the system’s adaptability to complex mounting scenarios where space is limited and pipes must be stacked. The supports may ensure that each pipe in the vertical run remains thermally isolated and protected from the point loads exerted by the cross-member supports of the vertical suspension element(s). Additional insulation may be provided along the length of the pipe between pipe hanger supports. The smooth and consistent end surfaces of the underlying insulating medium 1022 may improve ease of installation of such insulation, and may reduce likelihood of gaps in the insulation at the interfaces with the pipe hanger supports. For example, in contrast to devices of the prior art, which may not have clean seams that can easily be coupled to other sections of insulation along a pipe, devices of the present teachings may include clean, uniform edges that can abut existing insulation sections and be readily coupled thereto. For example, the clean edge of the insulating medium 1022 may be positioned directly against an adjacent insulation section and secured using tape, adhesive, seams, or similar coupling mechanisms. This configuration may allow the finished installation to maintain the integrity of the insulated system, as there may be no gaps, voids, or irregular interfaces between the pipe hanger support and the adjacent insulation portions along the pipe. The ability to create seamless transitions between the pipe hanger support and standard pipe insulation sections may help preserve thermal efficiency, prevent condensation issues, and reduce the risk of moisture infiltration at the interfaces. This improved interface compatibility may be particularly beneficial in applications requiring continuous vapor barrier protection, such as chilled water systems, where even small gaps in the insulation envelope can lead to condensation and potential corrosion under insulation.

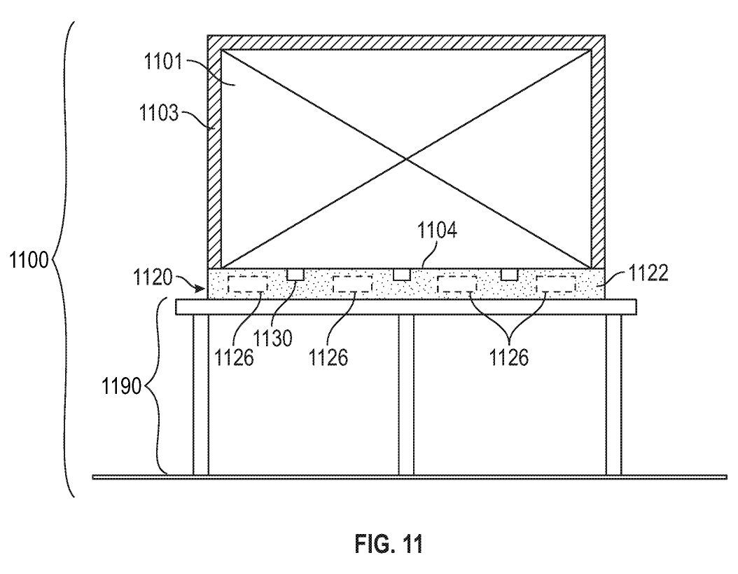

FIG. 11 shows a system for safeguarding insulation, according to a representative example. Specifically, the system 1100 may be configured for safeguarding insulation about a structure other than a pipe, e.g., a duct 1101. That is, it shall be understood that any one or more of the supports described herein—e.g., with reference to any of FIGS. 1–10 above—may be adapted for, or otherwise used to be an insulating support 1120 for a duct 1101 or another similar component or structure. That is, a duct 1101 may include insulation 1103 (and/or another protective element or similar) about at least a portion of its outer surface, where such insulation 1103 (or similar) may be susceptible to crushing (or other damage or similar) that can affect its insulating properties (and/or other protective properties), especially between a bottom surface 1104 of the duct 1101 and a support structure 1190. To this end, an insulating support 1120 may be used that contains one or more of the features of the pipe hanger supports (and similar) described herein. The insulating support 1120 may include ends that define a length of an insulating medium 1122 that is structurally configured for placement between the duct 1101 and a portion of a support structure 1190. The insulating support 1120 may further include one or more support inserts 1126 and/or one or more fasteners 1130.

The duct 1101 may, for example, be a component of ductwork for a heating, ventilation, and air conditioning (HVAC) systems, which may include various shapes and sizes of conduits used for air distribution. While typically rectangular or circular in cross-section, such ducts may also or instead have oval, square, or custom profiles to accommodate specific installation requirements. Such ducts may be indoor and/or outdoor types of ductwork. The insulating support 1120 described herein may be used for such ducts 1101 and/or other similar structures. That is, it will be understood that the supports described herein may be adapted for use with a wide range of structures beyond traditional HVAC ducts. For example, insulating supports 1120 may be utilized with large diameter pipes, such as those found in industrial processing plants or municipal water systems. They may also or instead be applied to protect insulation on structural beams, columns, or other load-bearing elements in buildings, e.g., where thermal bridging may be a concern. In some implementations, the supports may be adapted for use with cable trays, electrical conduits, or other utility conveyance systems that include insulation protection or the like. Additionally, an insulating support 1120 may be modified for use with tanks, vessels, or other large structures that have insulation protection at support points. The versatility of embodiments of such insulating supports 1120 may allow for their application in various fields including, but not limited to, construction, manufacturing, energy production, transportation infrastructure, and the like.

The insulating medium 1122 may be the same as, or similar to, any as described herein. For example, the insulating medium 1122 may be formed as a continuous body defining a length between a first end and a second end. The length may be selected to substantially envelop the outer circumference of a structure such as a duct 1101 or similar. Alternatively, the length may be selected to substantially conform to a length of a bottom surface 1104 (or other surface(s)) of the duct 1101 (e.g., the length may be substantially equal to, or greater than, a width of the duct). In some aspects, the length may extend beyond the length of the bottom surface 1104 of the duct 1101, but may not have sufficient length to envelop the outer surface of the duct 1101. In some aspects, the ends of the insulating medium 1122 may include fastening components such as any as described herein, e.g., for coupling the ends to one another, and/or for coupling an end of the insulating medium 1122 to the duct 1101 or another structure. In certain implementations, the insulating medium 1122 may be made from a weatherproof material such as rubber or the like.

One or more support inserts 1126 may be embedded within the continuous body of the insulating medium 1122 at predefined locations along its length. The support inserts 1126 may be any as described herein, e.g., including mica, a calcium silicate material, a high-density molded fiberglass, a phenolic foam, a polymer, a wood, a metal, and the like. In some aspects, such as that shown in the figure, the system 1100 may include four or more support inserts 1126, e.g., where each insert may be the same.

The one or more fasteners 1130 may be any as described herein. In some aspects, a fastener 1130 may include a magnet that can magnetically couple the insulating support 1120 to the duct 1101, e.g., in a removable and replaceable manner which can be advantageous for alignment and ease of installation. Other types of temporary fasteners 1130 may also or instead be used to secure the insulating support 1120 to the duct 1101. The fasteners 1130 may be embedded within, or otherwise disposed on a surface of, the insulating medium 1122. The one or more fasteners 1130 may also or instead include permanent fasteners structurally configured to permanently couple the insulating support 1120 to the duct 1101.

As described herein, aspects of the present teachings may offer a plurality of advantages over other existing techniques used to protect insulation at pipe hanger locations and/or other support locations. By way of example, the present teachings may include a support that is one piece instead of two pieces which may, e.g., simplify manufacturing, shipping, storage, installation, or the like. By way of further example, in implementations where the support includes an insulating medium such as rubber or the like, such materials may include increased durability and/or longevity compared to other materials such as calcium silicate and the like. Also or instead, such materials may be weatherproof (e.g., inherently weatherproof, or adapted to be weatherproofed relatively easily), where aspects of the present teachings may not need to be further weatherproofed such as by being wrapped in plastic to keep moisture out as is often done with materials such as calcium silicate and the like. By way of further example, aspects of the present teachings may provide for a relatively easy installation—e.g., using a hook and loop fastener, magnetic fasteners, and/or the like which may make it simple for an installer to properly align and/or secure a support, and/or permanently secure the support within the system (e.g., via a self-sealing lap or the like). By way of further example, aspects of the present teachings may provide for a way to add components between the support and the pipe, such as a heat trace cable or similar—e.g., a non-permanent fastener may secure a support in place, where this fastener can be undone to run a heat trace cable or similar between the support and the pipe, and then sealed thereafter, temporarily and/or permanently. In certain aspects, the present teachings include a true chilled water pipe hanger insert that can create a vapor barrier and provide proper insulation for, e.g., chilled water pipe at an operating temperature around 42 degrees Fahrenheit.

It will be understood that one or more components of the devices and systems described herein may be configured to comply with rigorous industry standards to ensure the integrity of the installation. By way of example, an insulating medium and associated components according to the present teachings may be configured to meet ASTM E84 and/or UL723 standards for flame spread and smoke development (e.g., the support components may have a 25/50 rating). Additionally, a pipe hanger support according to the present teachings may be dimensioned and/or structurally reinforced to comply with support spacing requirements per MSS SP-58 (Table 4) and energy code requirements such as IECC (Table C403.12.3). Such compliance can ensure that the integrity of the system extends beyond physical structure to regulatory and safety performance.

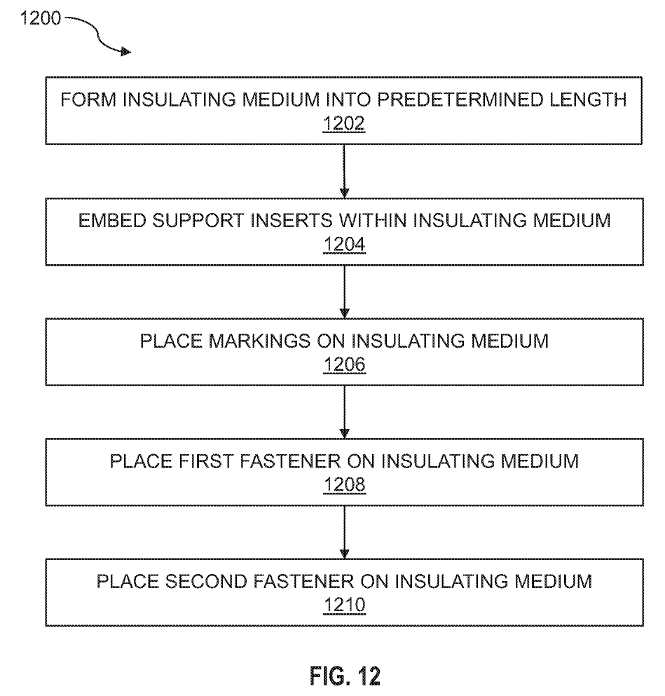

FIG. 12 shows a flow chart of a method of manufacturing a pipe hanger support for safeguarding insulation, according to a representative example. It will be understood that the method 1200 may be used to form one or more of the pipe hanger supports described herein, e.g., with reference to any of the figures above or below. In general, the method 1200 may provide a structured approach for producing pipe hanger supports with embedded support inserts and appropriate fastening mechanisms according to the present teachings.

As shown in step 1202, the method 1200 may include forming an insulating medium into a predetermined length having a first end and a second end. This step 1202 may involve cutting elastomeric rubber or the like to a predetermined length and width. The predetermined length may correspond to an external circumference of a pipe for which the pipe hanger support is intended to envelop. Forming the insulating medium may include cutting material of the insulating medium to the predetermined length using techniques, such as die cutting, water jet cutting, laser cutting, or the like, to ensure precise dimensions.

As shown in step 1204, the method 1200 may include embedding one or more support inserts within the insulating medium. This step 1204 may involve removal of material of the insulating medium to form a void, and placing at least one of the one or more support inserts within the void. The removal of material may be accomplished through methods such as punching, routing, milling, water jet cutting, or the like—to create voids sized and positioned for the support inserts. Such voids may extend through an entire thickness of the insulating medium, or may extend to a predetermined depth within the insulating medium. The support inserts may be embedded with a predetermined spacing between the inserts. Embedding the support inserts may include placing a support insert in each void (e.g., such that the support insert is closely retained within the void), and/or applying an adhesive to retain the support insert in position within the insulating medium. In other implementations, the support inserts may be embedded by molding the insulating medium directly around the inserts during manufacturing, such as through injection molding or compression molding processes where the elastomeric material is formed with the support inserts already positioned within the mold cavity. Embedding the support inserts may also or instead include applying a covering (e.g., a tape, seal, jacket, or the like) over a void when a support insert is embedded therein. The covering may serve to secure the support inserts within the insulating medium, preventing displacement during handling, shipping, or installation, while also providing or maintaining a vapor barrier across the region where the support insert is embedded. Additionally, the covering may include a visually distinct appearance, such as a contrasting color or texture, that serves as a marker or easily identifying feature indicating the location of the embedded support inserts, thereby aiding installers in properly aligning the pipe hanger support during installation. The insulating medium may also or instead be assembled from multiple sections that are bonded together with the support inserts positioned at the interfaces between sections.

The support inserts may be embedded at a first location along the length of the insulating medium. The first location may be selected such that insulating medium, when wrapped about the pipe, envelops the pipe with the one or more support inserts disposed adjacent to a bottom end of the pipe for positioning between the bottom end of the pipe and a pipe hanger. The support inserts may also or instead be embedded at a second location along the length. The second location may be selected such that the insulating medium, when wrapped about the pipe, envelops the pipe with the one or more support inserts disposed adjacent to a top end of the pipe for positioning between the top end of the pipe and a top portion of a pipe hanger. Other locations are also or instead possible, such as any location along the length of the insulating medium.

As shown in step 1206, the method 1200 may include placing one or more markings on the insulating medium. As described herein, these markings may serve multiple practical functions, including indicating alignment guides for proper positioning during installation, identifying the locations of embedded support inserts, providing directional indicators, displaying measurement references for different pipe sizes, and/or including product specifications such as temperature ratings and manufacturer information. The markings may be applied through printing, embossing, and/or other permanent application methods during manufacturing to ensure they remain visible throughout the product’s service life, thereby reducing installation errors and facilitating proper alignment with adjacent insulation sections for optimal thermal protection.

The method 1200 may also include sealing the insulating medium with a vapor barrier and/or weatherproof sealant. In one example, the vapor barrier is applied to the locations of the embedded inserts. For example, a manufacturing process may include sealing all inside rigid insert penetrations with vapor barrier weatherproof sealant. This may involve applying a specialized sealant around the edges of the support inserts where they interface with the insulating medium, ensuring that the vapor barrier properties of the insulating medium are maintained despite the insertion of the support components. Also or instead, the method 1200 may include sealing all outside rigid insert penetrations with flexible elastomeric weather proof vapor barrier tape or similar. This step may involve applying weatherproof tape over the external surfaces where the support inserts have been embedded, providing an additional layer of protection against moisture ingress and maintaining the overall integrity of the vapor barrier. This step may also or instead involve applying a coating or treatment to the entire surface of the insulating medium to enhance its weatherproofing properties and ensure consistent vapor barrier performance across the entire pipe hanger support. Thus, the vapor barrier may be applied to a plurality of portions of the insulating medium—e.g., the entire body thereof. The method 1200 may also include applying a protective jacket to an external surface of the insulating medium. This protective jacket may be formed from materials such as plastic, PVC, aluminum, stainless steel, or other weatherproof coverings that provide additional protection against environmental factors, mechanical damage, and UV exposure while enhancing the overall durability and appearance of the pipe hanger support.

As shown in step 1208, the method 1200 may include placing a first fastener on one or more of the first end and the second end of the insulating medium. The first fastener may be structurally configured to selectively and releasably couple the first end and the second end of the insulating medium. This step 1208 may involve attaching hook and loop fasteners, snap fasteners, and/or other releasable coupling mechanisms to the designated ends of the insulating medium.

As shown in step 1210, the method 1200 may include placing a second fastener on one or more of the first end and the second end of the insulating medium. The second fastener may be configured to form a permanent bond between the first end and the second end of the insulating medium. This step 1210 may involve applying adhesive strips, heat-activated bonding materials, and/or other permanent fastening mechanisms to the designated ends of the insulating medium.

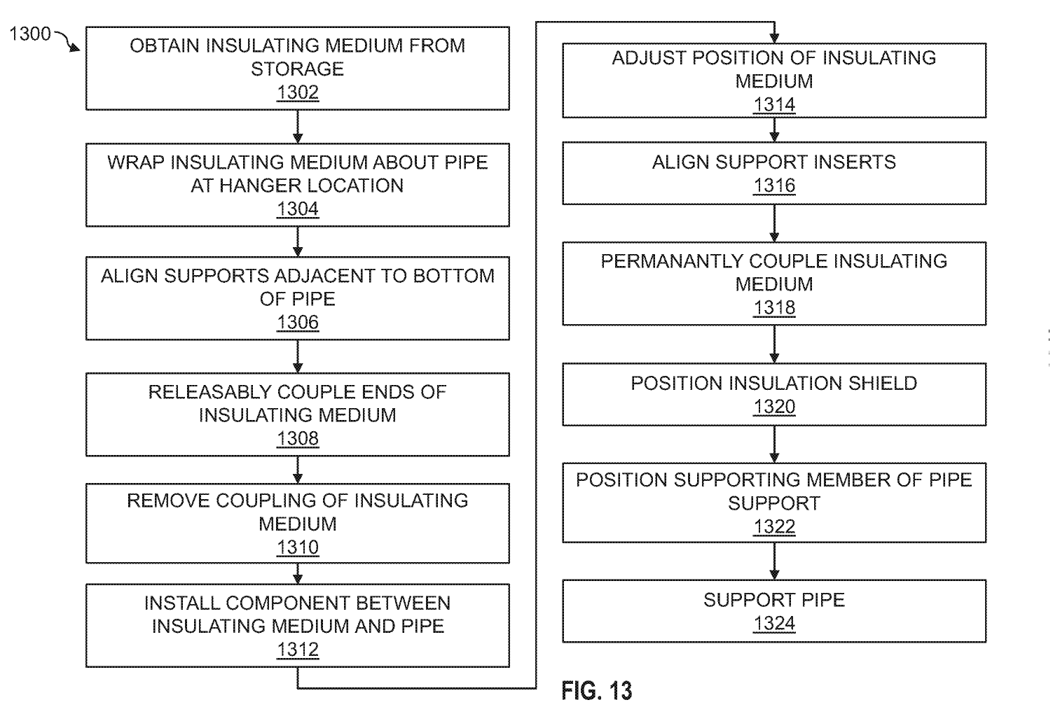

FIG. 13 shows a flow chart of a method of safeguarding insulation for a hanging pipe at a pipe hanger location, according to a representative example. The method 1300 may provide a structured approach for installing and adjusting a pipe hanger support to protect insulation integrity at critical hanger points. The method 1300 may be performed using, at least in part, one or more of the pipe hanger supports described herein, e.g., with reference to any of the figures herein.

As shown in step 1302, the method 1300 may include obtaining an insulating medium from a storage location where it may be stored substantially flat. The flat storage may allow for easier handling and reduced space requirements compared to pre-curved insulation components. In other aspects, the insulating medium may be stored in a predetermined shape, such as substantially cylindrical.

As shown in step 1304, the method 1300 may include wrapping the insulating medium about a pipe in a hanger location. The hanger location may be disposed where a pipe hanger supports, or will support, the pipe. The insulating medium may be any as described herein, for example, including a continuous body defining a length between a first end and a second end, one or more support inserts embedded within the continuous body at a first location along the length, and a first fastener disposed on one or more of the first end and the second end of the continuous body. The first fastener may be structurally configured to selectively and releasably couple the first end and the second end of the insulating medium.

As shown in step 1306, the method 1300 may include aligning the one or more support inserts adjacent to a bottom end of the pipe. This alignment may ensure that the support inserts are properly positioned to provide protection at the critical contact point between the pipe and the load-bearing member of the pipe hanger. In certain aspects, aligning the one or more support inserts may include use of an alignment guide disposed on the insulating medium. In some implementations, the method 1300 may also or instead include aligning at least one of the one or more support inserts adjacent to a top end of the pipe, and positioning a second supporting member of the pipe support adjacent to the top end of the pipe.

As shown in step 1308, the method 1300 may include releasably coupling the first end and the second end of the insulating medium via the first fastener. This temporary coupling may allow for initial positioning and adjustment of the insulating medium around the pipe before permanent attachment.

As shown in step 1310, the method 1300 may include uncoupling the first end and the second end of the insulating medium via the first fastener. This step 1310 may be performed if adjustments or access to the underlying pipe or components are needed after initial installation.

As shown in step 1312, the method 1300 may include installing a component between the insulating medium and the pipe. In certain aspects, the component may include heat tracing, although other components are also or instead possible, such as any as described herein or known in the art of piping systems. This step 1312 may allow for the integration of additional functional elements within the insulation system.

As shown in step 1314, the method 1300 may include adjusting a position of the insulating medium relative to the pipe. This adjustment may be necessary to accommodate a component installed in step 1312 and/or to optimize the positioning of the insulation protection.

As shown in step 1316, the method 1300 may include aligning at least one of the one or more support inserts adjacent to desired areas where protection of the insulation is desired, such as in areas susceptible to crushing forces from the pipe and/or pipe hanger. This step 1316 may provide additional protection for the insulation at contact points between the pipe and the pipe hanger. In some instances, step 1316 may include a realignment of the support inserts, e.g., after a component is installed under the pipe hanger support, or more generally before permanent coupling. Alignment guides and/or markings may assist such alignment.

As shown in step 1318, the method 1300 may include permanently coupling the first end and the second end of the insulating medium via a second fastener. In certain aspects, the second fastener may be disposed on the insulating medium. This permanent coupling may provide a secure and weatherproof seal around the pipe once the desired position of the insulating medium has been achieved.

As shown in step 1320, the method 1300 may include positioning an insulation shield adjacent to (e.g., beneath) the one or more embedded supports. The insulation shield may provide additional protection and load distribution between the pipe hanger support and the load-bearing member of the pipe hanger.

As shown in step 1322, the method 1300 may include positioning a supporting member of the pipe support beneath the insulation shield. This step 1322 may ensure proper alignment of the pipe hanger components and the insulation protection system.

As shown in step 1324, the method 1300 may include supporting the pipe using the pipe support. This step 1324 may involve engaging the pipe hanger to bear the weight of the pipe while the insulation protection system safeguards the integrity of the insulation at the hanger location.

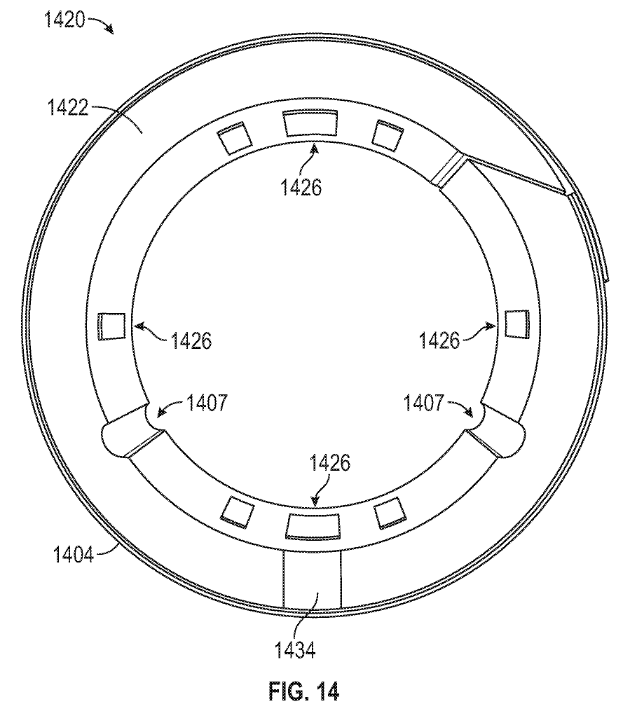

FIG. 14 shows a pipe hanger support 1420 for safeguarding insulation, according to a representative example. The pipe hanger support 1420 may be the same or similar to other pipe hanger supports described herein, and may thus include any one or more features of such supports and support systems, and vice-versa. In general, the pipe hanger support 1420 may include an insulating medium 1422 and one or more support inserts 1426 embedded therein at one or more locations about the internal circumference of the shape formed by the insulating medium 1422 (e.g., at one or more locations adjacent the pipe). The pipe support 1420 may also include an insulation shield 1404, that may have one or more members (e.g., a bottom saddle and/or a top shield) that may cooperate to substantially fully encase the circumference of the support and its underlying insulating medium 1422. In some aspects, the insulation shield 1404 may be formed from a heavy-gauge material, such as 16-gauge galvanized steel, to provide a robust layer of protection against high compressive loads, impact, and environmental debris. Members of the shield may overlap at an overlap region to ensure there are no gaps in the shield coverage; in other cases there may be a small gap between members of the insulation shield 1404. The support 1420 may include one or more channels 1407 formed in an inner surface of the insulating medium 1422. The channels 1407 may be sized and shaped to receive a pipeline component (e.g., a heat trace cable) therethrough. A vapor barrier may also be included on an exterior of the pipe support 1420. In certain applications, having an insulation shield 1404 that provides 360-degree encasement of the pipe may be particularly advantageous for preventing a U-bolt or hanger strap from cutting into the insulating medium 1422 or the vapor barrier 1440 under extreme loads or thermal expansion cycles. The support 1420 may include a marking 1434 on the insulating medium 1422. The marking 1434 may indicate at least one of: an alignment guide for placement at one or more of the bottom end of the pipe and the top end of the pipe, and a location of at least one of the plurality of support inserts. The marking 1434 may assist installers in properly positioning the support 1420 around a pipe to ensure desired load distribution and protection at contact points.

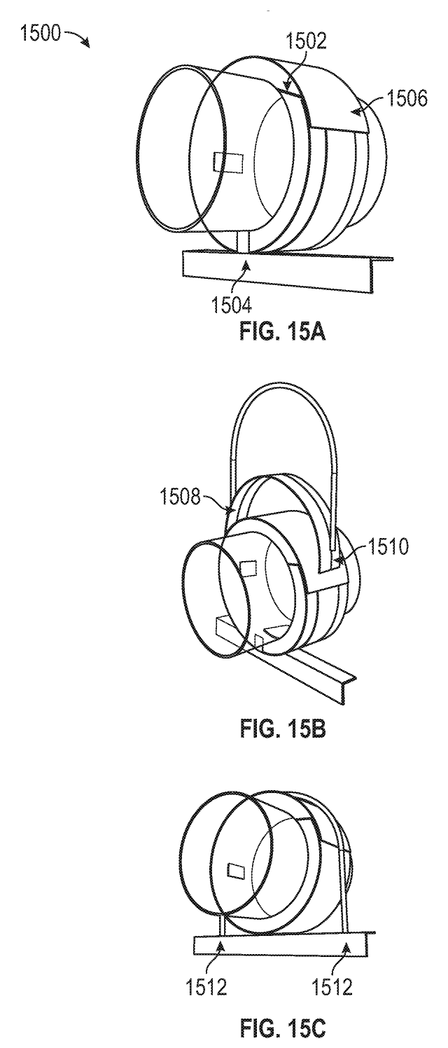

FIGS. 15A–15C show a system 1500 for safeguarding insulation in first, second, and third installation positions, respectively, according to representative examples. The system 1500 and methods of installation and/or use may be the same or similar to other systems or methods described herein, and may thus include any one or more features of such systems and or methods, and vice-versa.

As shown in FIG. 15A, an example installation process for a pipe hanger support may include a step 1502, pulling a pipe hanger support tightly around a pipe and aligning one or more fasteners. This step may include fastening one or more fasteners (e.g., a first fastener), and may also include ensuring that no gaps are present in the pipe hanger support with the fasteners secured. The installation process may also or instead include a step 1504, positioning the pipe hanger support to align a marking with a desired position (e.g., the bottom end of the pipe adjacent a supporting structure). The installation process may also or instead include a step 1506, fastening a permanent fastener (e.g., a second fastener). In an example, step 1506 may include removing a self-sealing lap of the fastener, and applying pressure and/or moisture to ensure a complete seal.

As shown in FIG. 15B, an example installation process for a pipe hanger support may include a step 1508, installing an insulation shield. The insulation shield may include multiple members as described herein; a top member of the insulation shield is shown being installed in this figure. The insulation shield may be secured to the pipe hanger support, such as with double-sided tape or other fasteners as described herein. The installation process may also or instead include a step 1510, positioning a hanger body (e.g., a U-bolt as shown) to align with a marking on the insulation shield, the insulating medium, or the like.

As shown in FIG. 15C, an example installation process for a pipe hanger support may include a step 1512, installing the hanger body. In the shown example, this step may include securing a U-bolt, or other hanger, with fasteners or the like.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings.

Unless the context clearly requires otherwise, throughout the description, the words “comprise,” “comprising,” “include,” “including,” and the like are to be construed in an inclusive sense as opposed to an exclusive or exhaustive sense; that is to say, in a sense of “including, but not limited to.” Additionally, the words “herein,” “hereunder,” “above,” “below,” and words of similar import refer to this application as a whole and not to any particular portions of this application.

It will be appreciated that the devices, systems, and methods described above are set forth by way of example and not of limitation. For example, regarding the methods provided above, absent an explicit indication to the contrary, the disclosed steps may be modified, supplemented, omitted, and/or re-ordered without departing from the scope of this disclosure. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context.

The method steps of the implementations described herein are intended to include any suitable method of causing such method steps to be performed, consistent with the patentability of the following claims, unless a different meaning is expressly provided or otherwise clear from the context. So, for example performing the step of X includes any suitable method for causing another party such as a remote user, a remote processing resource (e.g., a server or cloud computer) or a machine to perform the step of X. Similarly, performing steps X, Y, and Z may include any method of directing or controlling any combination of such other individuals or resources to perform steps X, Y, and Z to obtain the benefit of such steps. Thus, method steps of the implementations described herein are intended to include any suitable method of causing one or more other parties or entities to perform the steps, consistent with the patentability of the following claims, unless a different meaning is expressly provided or otherwise clear from the context. Such parties or entities need not be under the direction or control of any other party or entity, and need not be located within a particular jurisdiction.

While particular embodiments have been shown and described, it will be apparent to those skilled in the art that various changes and modifications in form and details may be made therein without departing from the spirit and scope of this disclosure and are intended to form a part of the invention as defined by the following claims, which are to be interpreted in the broadest sense allowable by law.

What is claimed is:

1. A support for safeguarding insulation at a pipe hanger location, the support comprising:
an insulating medium formed as a continuous body defining a length between a first end and a second end, the length selected to substantially envelop a circumference of a pipe, wherein each of the first end and the second end include a mating surface for coupling therebetween;
a plurality of support inserts embedded within the continuous body of the insulating medium, the plurality of support inserts comprising:
at least three primary support inserts positioned at a first location along the length of the insulating medium, the first location selected to be adjacent to at least one of a bottom end or a top end of the pipe when the insulating medium is wrapped about the pipe;
a first side support insert positioned at a second location along the length of the insulating medium, the second location selected to be adjacent to a first side of the pipe when the insulating medium is wrapped about the pipe; and
a second side support insert positioned at a third location along the length of the insulating medium, the third location selected to be adjacent to a second side of the pipe when the insulating medium is wrapped about the pipe;
a first fastener disposed on the mating surface of at least one of the first end and the second end of the insulating medium, the first fastener structurally configured to couple the first end and the second end;
a vapor barrier disposed on an exterior surface of the insulating medium; and
a second fastener at least partially disposed on the vapor barrier, the second fastener structurally configured to further couple the first end and the second end of the insulating medium.

2. The support of claim 1, wherein the at least three primary support inserts are spaced apart with a predetermined spacing selected to: distribute compressive forces substantially evenly across the insulating medium at the first location, and/or permit wrapping of the insulating medium about the pipe.

3. The support of claim 1, wherein the mating surface of one or more of the first end and the second end includes an angled or beveled edge that creates complementary mating surfaces when the first end and the second end are coupled.

4. The support of claim 1, wherein the first fastener selectively and releasably couples the first end and the second end of the insulating medium.

5. The support of claim 4, wherein the first fastener includes a hook and loop component.

6. The support of claim 1, wherein the second fastener permanently couples the first end and the second end of the insulating medium.

7. The support of claim 1, wherein one or more of the first fastener and the second fastener comprises an adhesive component.

8. The support of claim 1, wherein the second fastener comprises a self-sealing lap tape configured to overlay a location of the first fastener.

9. The support of claim 1, further comprising a breakaway seam disposed along the vapor barrier, the breakaway seam comprising a breakable connection between the first end and the second end that permits the support to be shipped in a substantially cylindrical configuration and opened for installation about the pipe.

10. The support of claim 1, further comprising a first insulation shield positioned adjacent to the first location for disposition between the pipe and a portion of a pipe hanger.

11. The support of claim 10, further comprising a second insulation shield positioned opposite the first location.

12. The support of claim 11, wherein the first insulation shield and the second insulation shield are configured to overlap to form a substantially continuous protective encasement around the insulating medium.

13. The support of claim 11, wherein one or more of the first insulation shield and the second insulation shield is formed from a metal material.

14. The support of claim 1, wherein the insulating medium comprises rubber.

15. The support of claim 1, wherein the insulating medium lacks calcium silicate.

16. The support of claim 1, wherein the plurality of support inserts include at least one of: mica, high-density molded fiberglass, calcium silicate, phenolic foam, a polymer, or wood.

17. The support of claim 1, further comprising one or more markings on the insulating medium indicating at least one of: an alignment guide for placement at one or more of the bottom end of the pipe and the top end of the pipe, and a location of at least one of the plurality of support inserts.

18. The support of claim 1, further comprising a channel formed in an inner surface of the insulating medium, the channel sized and shaped to receive a pipeline component therethrough.

19. A system for safeguarding insulation disposed about a pipe at a hanger location, the system comprising:
a pipe having a circumference with a top end and a bottom end;
a pipe hanger comprising:
a hanger body adapted to suspend from a support structure; and
a load-bearing member coupled to the hanger body, the load-bearing member structurally configured to receive and support the pipe along the bottom end thereof;
an insulation shield adapted for placement along the load-bearing member, between the load-bearing member and the bottom end of the pipe; and
a pipe hanger support comprising:
an insulating medium formed as a continuous body defining a length between a first end and a second end, the length selected to substantially envelop the circumference of the pipe, wherein each of the first end and the second end include a mating surface for coupling therebetween;
a plurality of support inserts embedded within the continuous body of the insulating medium, the plurality of support inserts comprising:
at least three primary support inserts positioned at a first location along the length of the insulating medium, the first location selected to be adjacent to at least one of a bottom end or a top end of the pipe when the insulating medium is wrapped about the pipe;
a first side support insert positioned at a second location along the length of the insulating medium, the second location selected to be adjacent to a first side of the pipe when the insulating medium is wrapped about the pipe; and
a second side support insert positioned at a third location along the length of the insulating medium, the third location selected to be adjacent to a second side of the pipe when the insulating medium is wrapped about the pipe;
a first fastener disposed on the mating surface of at least one of the first end and the second end of the insulating medium, the first fastener structurally configured to couple the first end and the second end;
a vapor barrier disposed on an exterior surface of the insulating medium; and
a second fastener at least partially disposed on the vapor barrier, the second fastener structurally configured to further couple the first end and the second end of the insulating medium.

20. A method of manufacturing a pipe hanger support for safeguarding insulation for a hanging pipe at a pipe hanger location, the method comprising:
forming an insulating medium into a continuous body having a predetermined length having a first end and a second end, the predetermined length selected to substantially envelop a circumference of a pipe, wherein each of the first end and the second end include a mating surface for coupling therebetween;
embedding within the continuous body of the insulating medium a plurality of support inserts including:
at least three primary support inserts at a first location along the predetermined length of the insulating medium, the first location selected to be adjacent to at least one of a bottom end or a top end of the pipe when the insulating medium is wrapped about the pipe;
a first side support insert at a second location along the predetermined length of the insulating medium, the second location selected to be adjacent to a first side of the pipe when the insulating medium is wrapped about the pipe; and
a second side support insert at a third location along the predetermined length of the insulating medium, the third location selected to be adjacent to a second side of the pipe when the insulating medium is wrapped about the pipe;
placing a first fastener on the mating surface of at least one of the first end and the second end of the insulating medium, the first fastener structurally configured to couple the first end and the second end;
placing a vapor barrier on an exterior surface of the insulating medium; and
placing a second fastener at least partially on the vapor barrier, the second fastener structurally configured to further couple the first end and the second end of the insulating medium.
